(19) United States
(12) Patent Application Publication
(10) Pub. No.: US 2025/0116597 A1
(43) Pub. Date: Apr. 10, 2025

(54) MODEL-BASED ACOUSTO-OPTIC DEPTH-METROLOGY OF SPECIMENS

(71) Applicant: Applied Materials Israel Ltd., Rehovot (IL)

(72) Inventors: Guy Shwartz, Ramat Gan (IL); Ido Almog, Rehovot (IL); Ori Golani, Kibbutz Shoval (IL)

(73) Assignee: Applied Materials Israel Ltd., Rehovot (IL)

(21) Appl. No.: 18/377,431

(22) Filed: Oct. 6, 2023

(51) Int. Cl. G01N 21/17; G01N 21/95; G06N 3/0455; G06N 3/084

(52) U.S. Cl. CPC G01N 21/1702; G01N 21/9501; G06N 3/0455; G06N 3/084; G01N 2021/1706

(57) ABSTRACT

Disclosed herein is a method for non-destructive depth-profiling including projecting a pulsed pump beam into a specimen, projecting a pulsed probe beam thereinto, and sensing light returned therefrom to obtain a measured signal. Each probe pulse is configured to undergo Brillouin scattering off a primary acoustic pulse induced by the directly preceding pump pulse, so as to be scattered there off at a respective depth within the specimen. The method further includes executing an optimization algorithm configured to receive as inputs the measured signal, and/or a processed signal obtained therefrom, and output values of structural parameter(s) characterizing the specimen through minimization of a cost function indicative of a difference between the measured signal and a simulated signal obtained using a forward model simulating the scattering of a pulsed probe beam off at least the primary acoustic pulses.

### TECHNICAL FIELD

The present disclosure relates generally to non-destructive metrology of specimens.

### BACKGROUND

With the shrinking of design rules, process control of semiconductor specimens grows ever more complex as metrology of increasingly smaller structures is required. State-of-the-art non-destructive techniques for metrology of semiconductor specimens primarily rely on scanning electron microscopy, optical critical dimension (OCD) scatterometry, and/or small angle X-ray scattering (SAXS). While each of these techniques has its own advantages, there nevertheless remains an unmet need in the art for rapid non-destructive techniques for metrology of semiconductor specimens, which afford greater accuracy.

### SUMMARY

Aspects of the disclosure, according to some embodiments thereof, relate to non-destructive metrology of specimens. More specifically, but not exclusively, aspects of the disclosure, according to some embodiments thereof, relate to non-destructive acousto-optic based depth-metrology of semiconductor specimens.

Thus, according to an aspect of some embodiments, there is provided a method for non-destructive acousto-optic depth-metrology of specimens. The method includes operations of:
Projecting a pulsed pump beam into a specimen to be profiled: Each pump pulse in the pulsed pump beam is configured to be absorbed in the profiled specimen, so as to induce formation of at least a respective primary acoustic pulse propagating within the profiled specimen.
Projecting a pulsed probe beam into the profiled specimen: Each probe pulse in the pulsed probe beam is configured to undergo Brillouin scattering off the primary acoustic pulse, which is induced by the respective pump pulse directly preceding the probe pulse, at a respective depth within the profiled specimen, so as to probe the profiled specimen across at least one range of depths (i.e. depths at which the probe pulses are scattered off the primary acoustic pulses, respectively).
Obtaining a measured signal by sensing light including a portion of the pulsed probe beam returned from the profiled specimen.
Subjecting the measured signal to processing to obtain a processed signal.
Executing an optimization algorithm configured to (i) receive as an input the processed signal, and (ii) output a set of structural parameters characterizing the profiled specimen through minimization of a cost function indicative of a difference between the processed signal and a simulated signal obtained using a forward model simulating the scattering of the probe pulses off at least the primary acoustic pulses.

According to some embodiments of the method, in each iteration thereof the optimization algorithm updates a guesstimate of the set of structural parameters and, based thereon, the simulated signal.

According to some embodiments of the method, the profiled specimen includes vias, which extend into the profiled specimen from a top surface of the profiled specimen. Each of the pump beam and the probe beam are projected on the top surface. The set of structural parameters at least partially characterizes a mean geometry of the vias.

According to some embodiments of the method, the set of structural parameters quantifies at least dependence on depth within the profiled specimen of a mean area of the vias.

According to some embodiments of the method, a depth of the vias is at least about 1 μm.

According to some embodiments of the method, a wavelength of the probe pulses is at least about two times greater than a nominal distance between adjacent vias.

According to some embodiments of the method, each of the pump pulses is configured to be absorbed in an absorbing slice of the profiled specimen, such that following formations thereof, each of the primary acoustic pulses propagates away from the absorbing slice.

According to some embodiments of the method, the profiled specimen is composed of a single material.

According to some embodiments of the method, the profiled specimen includes a plurality of layers including an absorbing layer, which includes the absorbing slice, and at least one other layer, such that, in addition, to each primary acoustic pulse, respective secondary acoustic pulses are formed as a result of partial reflection of the primary acoustic pulse off boundaries between adjacent layers. The forward model additionally takes into account the formation of the secondary acoustic pulses by additionally simulating the scattering of the probe pulses off at least some of the secondary acoustic pulses.

According to some embodiments of the method, the absorbing slice is constituted by a top sublayer (segment) of a bulk, on top of which a layered structure, including the rest of the layers, is disposed.

According to some embodiments of the method, the bulk is made of or includes silicon, and/or the rest of the layers are constituted by, made of, and/or include silicon oxide, silicon germanium, silicon nitride, an oxide-nitride-oxide (ONO) mixture stack, and/or a combination and/or mixture thereof.

According to some embodiments of the method, the pump pulses and the probe pulses are alternatingly projected.

According to some embodiments of the method, each of the probe pulses is delayed by a respective time delay relative to the directly preceding pump pulse, which is varied, so as to facilitate probing the profiled specimen across the at least one range of depths.

According to some embodiments of the method, the layered structure includes at least two layers. The time delay is varied such that some of the probe pulses are first scattered off the primary acoustic pulses, respectively, within a top layer of the layered structure, and other of the probe pulses are first scattered off the primary acoustic pulses, respectively, within a bottom layer of the layered structure, which is adjacent to the absorbing layer.

According to some embodiments of the method, a frequency of the probe pulses is such that the profiled specimen is substantially transparent thereto.

According to some embodiments of the method, the pump beam is a laser beam and/or the probe beam is a laser beam.

According to some embodiments of the method, the pump beam and the probe beam originate from a same laser source.

According to some embodiments of the method, wherein the profiled specimen includes the vias, in the forward model the profiled specimen is simulated by a laterally uniform specimen whose refractive index n(z) equals an effective refractive index n_{eff}(z) of the profiled specimen as predetermined based at least on reference data pertaining to the profiled specimen.

According to some embodiments of the method, an initial guesstimate, which is input into the forward model in a first iteration of the optimization algorithm, is derived taking into account at least reference data of the profiled specimen and/or previously obtained calibration data pertaining to the profiled specimen.

According to some embodiments of the method, in the forward model each of the simulated acoustic pulses is modelled by a semi-transparent mirror travelling at a local speed of sound.

According to some embodiments of the method, the forward model is derived using the optical transfer matrix method.

According to some embodiments of the method, values of model parameters of the forward model are tuned using machine learning techniques based at least on reference data of the profiled specimen.

According to some embodiments of the method, the reference data include design data of the profiled specimen, and/or ground truth data of specimens of a same, or a similar, design intent as the profiled specimen.

According to some embodiments of the method, the calibration data is obtained by implementing with respect to one or more scribe lines of the profiled specimen the operations of projecting the pulsed pump beam, projecting the pulsed probe beam, and sensing light returned from the profiled specimen.

According to some embodiments of the method, the method further includes an initial operation of calibrating values of model parameters of the forward model based on the calibration data.

According to some embodiments of the method, the cost function is a sum of squares and the optimization algorithm is a Levenberg-Marquardt algorithm.

According to some embodiments of the method, the processed signal is indicative of a Brillouin oscillations contribution to the measured signal.

According to some embodiments of the method, the processed signal quantifies at least a dependence of a Brillouin frequency, and/or a Brillouin amplitude of the Brillouin oscillations, on the (scattering) depth within the profiled specimen.

According to some embodiments of the method, wherein the pump beam and the probe beam originate from a same laser source, an envelope of the pump beam is amplitude modulated, and, in order to obtain, or as part of obtaining, the processed signal, the measured signal is demodulated using a lock-in amplifier which is fed the modulation frequency of the envelope.

According to some embodiments of the method, in obtaining the processed signal a thermo-optic contribution to the measured signal is removed.

According to some embodiments of the method, the pump pulses are of a different wavelength than the probe pulses, and, in obtaining the measured signal, an optical filter is used to filter out a returned component of the pump beam.

According to some embodiments of the method, the profiled specimen is or includes a V-NAND, a DRAM, or a 3D DRAM or a preliminary structure in an intermediate fabrication stage of a V-NAND, a DRAM, or a 3D DRAM.

According to some embodiments of the method, the profiled specimen is or forms part of a patterned wafer or a preliminary structure in an intermediate fabrication stage of a patterned wafer.

According to some embodiments of the method, wherein (i) the profiled specimen includes the vias, wherein (ii) in the execution of the optimization algorithm the initial guesstimate is input into the optimization algorithm, and wherein (iii) the set of structural parameters quantifies the dependence on depth within the profiled specimen of a mean area of the vias, in order to obtain the initial guesstimate a short-time Fourier transform (STFT) is applied to the processed signal to extract a preliminary estimate of a dependence on the time delay of a Brillouin frequency. Based on the preliminary estimate of the dependence on the time delay of the Brillouin frequency, a dependence on depth of a mean area of the vias is extracted.

According to some embodiments of the method, wherein the profiled specimen includes the plurality of layers, an iterative procedure is applied to obtain the initial guesstimate, whereby the processed signal is modelled by a sine series with terms corresponding to respective contributions to the processed signal of Brillouin scatterings off the primary acoustic pulse and at least some of the secondary acoustic pulses within each of the layers.

According to some embodiments of the method, the set of structural parameters includes a plurality of subsets of structural parameters, such that each subset of structural parameters includes at least one vertically localized parameter pertaining to one of a set of non-overlapping vertical increments {Δzᵢ}ᵢ with zᵢ being a height of the i-th vertical increment Δzᵢ within the specimen. (An index on curly brackets serves to denote that the index is generally a running index.) The optimization algorithm is executed with respect to each of the zᵢ, starting from z₁ and sequentially proceeding upwards, such that in the i-th execution the optimization algorithm (i) receives as an input the processed signal up to time tᵢ=Σ_{j≤i}Δzⱼ/vₛ(zⱼ) with vₛ(zⱼ) denoting the speed of sound about zⱼ, and/or a processed signal obtained from the measured signal up to time tᵢ, and, optionally, any previously obtained values of the at least one vertically localized parameter, and (ii) outputs values of the respective at least one vertically localized parameter.

According to some embodiments of the method, the operation of subjecting the measured signal to processing includes as a latter suboperation thereof, applying a bridge architecture to an initially processed signal, thereby obtaining the (final) processed signal. The initially processed signal is the product of all suboperations of the operation of subjecting the measured signal to processing before the latter suboperation.

According to an aspect of some embodiments, there is provided a system for non-destructive acousto-optic depth-metrology of structures. The system includes:
An (acousto-optic) measurement setup for:
   Projecting on a specimen, which is to be profiled, a pulsed pump beam, such that each pump beam in the pulsed pump beam is absorbed in the profiled specimen and induces formation of at least a respective primary acoustic pulse propagating within the profiled specimen.
   Projecting a pulsed probe beam into the profiled specimen such that each probe pulse in the pulsed probe beam undergoes Brillouin scattering off the primary acoustic pulse, which is induced by the respective pump pulse directly preceding the probe pulse, at a respective depth within the profiled specimen, so as to probe the profiled specimen across at least one range of depths (i.e. depths at which the probe pulses are scattered off the primary acoustic pulses, respectively).
   Obtaining a measured signal by sensing light including a portion of the pulsed probe beam returned from the profiled specimen.
A processing circuitry for executing an optimization algorithm, which is configured to (i) receive as an input a processed signal derived from the measured signal, and (ii) output a set of structural parameters characterizing the profiled specimen through minimization of a cost function indicative of a difference between the processed signal and a simulated signal obtained using a forward model simulating the scattering of the probe pulses off at least the primary acoustic pulses.

According to some embodiments of the system, the processing circuitry is further configured to derive the processed signal from the measured signal.

According to some embodiments of the system, the optimization algorithm is configured to update, following each iteration thereof, a guesstimate of the set of structural parameters, and based thereon, the simulated signal.

According to some embodiments of the system, the measurement setup includes light generating equipment and at least one light sensor. The light generating equipment is configured to generate the pulsed pump beam and the pulsed probe beam. The at least one light sensor is configured to measure an intensity of light incident thereon, thereby obtaining the measured signal.

According to some embodiments of the system, the at least one light sensor is configured to sense light from the profiled specimen at each of a plurality of optical modes specified by one or more of wavelength and polarization.

According to some embodiments of the system, the at least one light sensor includes a plurality of light sensors and/or a light sensor array.

According to some embodiments of the system, the measurement setup further includes a controller configured to command and coordinate operation of components of the measurement setup.

According to some embodiments of the system, the pump beam is a laser beam and/or the probe beam is a laser beam.

According to some embodiments of the system, the light generating equipment includes a laser source, and each of the pump beam and the probe beam originate from the laser source.

According to some embodiments of the system, the light generating equipment further includes an optical modulator, which is configured to amplitude-modulate the pump beam. The processing circuitry includes a lock-in amplifier, which is configured to use a modulation frequency of the pump beam to demodulate the measured signal in order to obtain the processed signal or as part of obtaining the processed signal.

According to some embodiments of the system, a modulation frequency of the pump beam is smaller than about 10 MHz.

According to some embodiments of the system, the profiled specimen includes vias, which extend into the profiled specimen from a top surface of the profiled specimen. The measurement setup is configured to project each of the pump beam and the probe beam on the top surface. The set of structural parameters at least partially characterizes a mean geometry of the vias.

According to some embodiments of the system, the set of structural parameters quantifies at least a dependence on depth within the profiled specimen of a mean area of the vias.

According to some embodiments of the system, a depth of the vias is at least about 1 μm.

According to some embodiments of the system, a wavelength of the probe pulses is at least about two times greater than a nominal distance between adjacent vias.

According to some embodiments of the system, each of the pump pulses is configured to be absorbed in an absorbing slice of the profiled specimen, such that following formation thereof, each of the primary acoustic pulses propagates away from the absorbing slice.

According to some embodiments of the system, the profiled specimen is composed of a single material.

According to some embodiments of the system, the profiled specimen includes a plurality of layers including an absorbing layer, which includes the absorbing slice, and at least one other layer, such that, in addition, to each primary acoustic pulse, respective secondary acoustic pulses are formed as a result of partial reflection of the primary acoustic pulse off boundaries between adjacent layers. The forward model additionally takes into account the formation of the secondary probe pulses by additionally simulating the scattering of the pulsed probe beam off at least some of the secondary acoustic pulses.

According to some embodiments of the system, the absorbing slice is constituted by a top sublayer of a bulk, on top of which a layered structure, including the rest of the layers, is disposed.

According to some embodiments of the system, the bulk is made of or includes silicon and/or the rest of the layers are constituted by, made of, and/or include silicon oxide, silicon germanium, silicon nitride, an oxide-nitride-oxide (ONO) mixture stack, and/or a combination and/or mixture thereof.

According to some embodiments of the system, the measurement setup is configured to alternately project the pump pulses and the probe pulses.

According to some embodiments of the system, the measurement setup is configured to delay by a controllably variable time interval each probe pulse relative to the directly preceding pump pulse, so as to facilitate probing the profiled specimen across the at least one range of depths.

According to some embodiments of the system, wherein the profiled specimen includes a layered structure mounted on top of a bulk that includes the absorbing slice, and the layered structure includes at least two layers, the time intervals are varied such that some of the probe pulses are first scattered off the primary acoustic pulses, respectively, within a top layer of the layered structure, and other of the probe pulses are first scattered off the primary acoustic pulses, respectively, within a bottom layer of the layered structure, which is adjacent to the absorbing layer.

According to some embodiments of the system, a frequency of the probe pulses is such that the layered structure is substantially transparent thereto.

According to some embodiments of the system, in the forward model the profiled specimen is simulated by a laterally uniform specimen whose refractive index n(z) equals an effective refractive index n_{eff}(z) of the profiled specimen as predetermined based on reference data pertaining to the profiled specimen.

According to some embodiments of the system, an initial guesstimate, which is input into the forward model in a first iteration of the optimization algorithm, is derived taking into account at least reference data of the profiled specimen and/or previously obtained calibration data pertaining to the profiled specimen.

According to some embodiments of the system, the reference data include design data of the profiled specimen, and/or ground truth data of specimens of a same, or a similar, design intent as the profiled specimen.

According to some embodiments of the system, in the forward model each of the simulated acoustic pulses is modelled by a semi-transparent mirror travelling at a local speed of sound.

According to some embodiments of the system, the forward model is derived using an optical transfer matrix method.

According to some embodiments of the system, tuned values of model parameters of the forward model are obtained by applying machine learning tools to at least reference data of the profiled specimen.

According to some embodiments of the system, at least some of the calibration data are obtained utilizing the system to depth-profile one or more scribe lines of the profiled specimen.

According to some embodiments of the system, at least some model parameters of the forward model are obtained based on, or also on, calibration data of the profiled specimen.

According to some embodiments of the system, the cost function is a sum of squares and the optimization algorithm is a Levenberg-Marquardt algorithm.

According to some embodiments of the system, the processed signal is indicative of a Brillouin oscillations contribution to the measured signal.

According to some embodiments of the system, the processed signal quantifies at least a dependence of a Brillouin frequency, and/or a Brillouin amplitude of the Brillouin oscillations, on the (scattering) depth within the profiled specimen.

According to some embodiments of the system, the processing circuitry is configured to, as part of obtaining the processed signal, remove a thermo-optic contribution to the measured signal.

According to some embodiments of the system, the measurement setup further includes an optical filter configured to filter out a returned component of the pump beam.

According to some embodiments of the system, the profiled specimen is or includes a V-NAND, a DRAM, or a 3D DRAM or a preliminary structure in an intermediate fabrication stage of a V-NAND, a DRAM, or a 3D DRAM.

According to some embodiments of the system, the profiled specimen is or forms part of a patterned wafer or a preliminary structure in an intermediate fabrication stage of a patterned wafer.

According to some embodiments of the system, wherein the set of structural parameters quantifies the dependence on depth within the profiled specimen of a mean area of the vias, in order to obtain an initial guesstimate of the dependence on the depth within the profiled specimen of the mean area of the vias, the processing circuitry is configured to apply a short-time Fourier transform (STFT) to the processed signal to extract a preliminary estimate of a dependence on the time delay of a Brillouin frequency.

According to some embodiments of the system, wherein the profiled specimen includes a plurality of layers, in order to obtain the initial guesstimate, the processing circuitry is configured to apply an iterative procedure, whereby the processed signal is modelled by a sine series with terms corresponding to respective contributions to the processed signal of Brillouin scatterings off the primary acoustic pulse and at least some of the secondary acoustic pulses within each of the layers.

According to some embodiments of the system, the set of structural parameters includes a plurality of subsets of structural parameters, such that each subset of structural parameters includes at least one vertically localized parameter pertaining to one of a set of non-overlapping vertical increments {Δzᵢ}ᵢ with zᵢ being a height of the i-th vertical increment Δzᵢ within the specimen. The processing circuitry is configured to execute the optimization algorithm with respect to each of the zᵢ, starting from z₁ and sequentially proceeding upwards, such that in the i-th execution the optimization algorithm (i) receives as an input the processed signal up to time tᵢ=Σ_{j≤i}Δzⱼ/vₛ(zⱼ) with vₛ(zⱼ) denoting the speed of sound about zⱼ, and/or a processed signal obtained from the measured signal up to time tᵢ, and. optionally, any previously obtained values of the at least one vertically local parameter, and (ii) outputs values of the respective at least one vertically localized parameter.

According to some embodiments of the system, the processing circuitry is configured to, as part of obtaining the processed signal, apply a bridge architecture to an initially processed signal. The initially processed signal is obtained by subjecting the measured signal to initial processing.

According to an aspect of some embodiments, there is provided a non-transitory computer-readable storage medium. The storage medium stores instructions that cause a system for non-destructive acousto-optic depth-metrology of structures, such as the above-described system, to implement the above-described method with respect to a (profiled) specimen.

According to an aspect of some embodiments, there is provided a non-transitory computer-readable storage medium. The storage medium stores instructions that cause one or more processors to execute an optimization algorithm, which is configured to (i) receive as an input a processed signal derived from a measured signal pertaining to a profiled specimen, and (ii) output a set of structural parameters characterizing the profiled specimen. The measured signal obtained by:
Projecting a pulsed pump beam into a specimen to be profiled: Each pump pulse in the pulsed pump beam is configured to be absorbed in the profiled specimen, so as to induce formation of at least a respective primary acoustic pulse propagating within the profiled specimen.
Projecting a pulsed probe beam into the profiled specimen: Each probe pulse in the pulsed probe beam is configured to undergo Brillouin scattering off the primary acoustic pulse, which is induced by the respective pump pulse directly preceding the probe pulse, at a respective depth within the profiled specimen, so as to probe the profiled specimen across at least one range of depths.
Sensing light including a portion of the pulsed probe beam returned from the profiled specimen.

The optimization algorithm involves minimization of a cost function indicative of a difference between the processed signal and a simulated signal obtained using a forward model simulating the scattering of the probe pulses off at least the primary acoustic pulses.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, flash memories, solid state drives (SSDs), or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

The patent or application file contains at least one drawing executed in color. Copies of this patent or patent application publication with color drawing(s) will be provided by the Office upon request and payment of the necessary fee.

In the figures:

FIG. 1 presents a flowchart of a computer implemented method for non-destructive acousto-optic depth-metrology of structures, according to some embodiments.

FIGS. 2A to 2D schematically depict different stages in an application of the method of FIG. 1, according to some embodiments thereof, to a structure.

FIGS. 3A and 3B schematically depict different stages in an application of the method of FIG. 1, according to some embodiments thereof, to a structure.

FIG. 4 is a flowchart of a measurement data processing operation for determining a set of structural parameters of a structure, which corresponds to specific embodiments of a measurement data processing operation of the method of FIG. 1, according to some embodiments thereof.

FIG. 5A depicts an encoder-decoder based computational architecture for bridging a simulative gap between simulation signals and actual signals, which are derived from measurement data obtained by implementing the measurement operation of the method of FIG. 1, according to some embodiments thereof.

FIG. 5B depicts an autoencoder configured for training the encoder of FIG. 5A, according to some embodiments.

FIG. 5C depicts an autoencoder for training the decoder of FIG. 5A, according to some embodiments.

FIG. 6 presents a flowchart of a computer implemented method for non-destructive acousto-optic depth-metrology of layered structures, which corresponds to specific embodiments of the method of FIG. 1.

FIGS. 7A to 7G schematically depict different stages in an application of the method of FIG. 6, according to some embodiments thereof, to a layered structure.

FIG. 8 provides a graphical representation of a scattering of a probe pulse off acoustic pulses within a layered structure in the context of a forward model, wherein each of the acoustic pulses is modelled by a semi-transparent mirror travelling at the local speed of sound, according to some embodiments.

FIG. 9 is a time-depth diagram illustrating formation and propagation of acoustic pulses in the forward model of FIG. 8, according to some embodiments.

FIGS. 10A to 10C schematically depict different stages in an application of the method of FIG. 6, according to some embodiments thereof, to a layered structure.

FIG. 11 depicts a voltage signal as a function of the time delay Δt between consecutive probe pulses and directly preceding pump pulses, which are projected on the layered structure of FIGS. 10A-10C in accordance with the method of FIG. 6, according to some embodiments thereof.

FIG. 12 presents a computerized system for non-destructive acousto-optic depth-metrology, according to some embodiments.

FIG. 13 presents a computerized system for non-destructive acousto-optic depth-metrology, which corresponds to specific embodiments of the system of FIG. 12.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

State-of-the-art non-destructive techniques for metrology of semiconductor specimens primarily rely on scanning electron microscopy, optical critical dimension (OCD) scatterometry, or small angle X-ray scattering (SAXS). Scanning electron microscopy allows for high-resolution (two-dimensional) imaging of top surfaces of specimens (e.g. semiconductor specimens) but may be poor at detecting or distinguishing below-surface structural features and deep lying parts. In contrast, OCD scatterometry is typically sensitive to buried structural features-provided that the specimen is optically transparent—but is often incapable of characterizing buried structures: If two or more parameters of a buried structure are simultaneously changed, OCD scatterometry might not be able to distinguish between them. For example, so long as the optical path length of a traversing optical beam remains unchanged (e.g. under a simultaneous change of the dimensions and the refractive index of a buried structure), the change will not be detected.

Recently, a novel non-destructive approach to depth-metrology has been developed. The approach is based on inducing acoustic pulses within a specimen and Brillouin scattering of a pulsed probe beam off the acoustic pulses. The acoustic pulses are induced through localized heating of the specimen resulting from the absorption of a pulsed pump beam projected on the specimen. A measured signal is obtained by sensing a returned portion of the probe beam. The measured signal may be analyzed to extract features characterizing the excited (Brillouin) oscillations, such as the Brillouin frequency shift or the amplitude of the Brillouin oscillations. The extracted features may be analyzed to determine structural parameters of the specimen.

The present application advantageously discloses improved techniques for analyzing the measured signal based on optimization involving a forward model. The forward model simulates the scattering of the probe pulses off the induced acoustic pulses. In addition, the present application teaches how to account for multiple scattering events of a single probe pulse. More specifically, in layered structures, an induced first acoustic pulse (referred to as “primary”) may, in turn, induce a plurality of secondary acoustic pulses through the partial reflection of the first acoustic pulse off the boundaries between adjacent layers. A single probe pulse will therefore be (Brillouin) scattered not only off the primary acoustic pulse but also off the secondary acoustic pulses, which will manifest as additional oscillating contributions to the measured signal. These additional contributions render more challenging the extraction of features, such as the Brillouin frequency shifts or the amplitudes of the Brillouin oscillations. The present application discloses various ways to address this challenge using a forward model. Finally, the present application discloses ways whereby parameters of the forward model may be calibrated using scribe line data.

To render the description clearer, throughout the description, certain symbols (e.g. letters) may be used exclusively to label specific types of parameters and/or quantities. For example, the letter v is used to denote the speed of sound within a specimen (or the local speed of sound when the specimen is non-uniform) and the letter u is used to denote the depth within a specimen or the scattering depth within a specimen (e.g. the depth at which a probe pulse is Brillouin scattered off an acoustic pulse propagating within the specimen). The symbol T_{F} is used to denote the formation of an acoustic pulse within a specimen due to the absorption of an (optical) pump pulse within the specimen. The symbol Δt is used to denote the time interval by which the incidence of an (optical) probe pulse on a specimen is delayed relative to the incidence of an immediately preceding pump pulse. Such symbols should not be construed as being tied to a specific embodiment with respect to which they are first introduced in the text. That is, use of such a symbol in the context of one embodiment does not carry over to another embodiment, unless it is implicit from the text that the properties described are general. In particular, for example, in the context of a first embodiment, a “speed of sound v”, a “depth u”, a “formation time T_{F}”, and a “time delay Δt” may be introduced, which may then be referred to in the description of the first embodiment as “the speed of sound v”, “the depth u”, “the formation time T_{F}”, and “the time delay Δt”, respectively (or simply “v” and “u”, respectively). Following which, in the context of a second embodiment, a “speed of sound v”, a “depth u”, a “formation time T_{F}”, and a “time delay Δt” may again be introduced, and, unless otherwise specified or implied, no properties described in the context of the first embodiment will be assumed as relevant in the context of the second embodiment.

### Methods

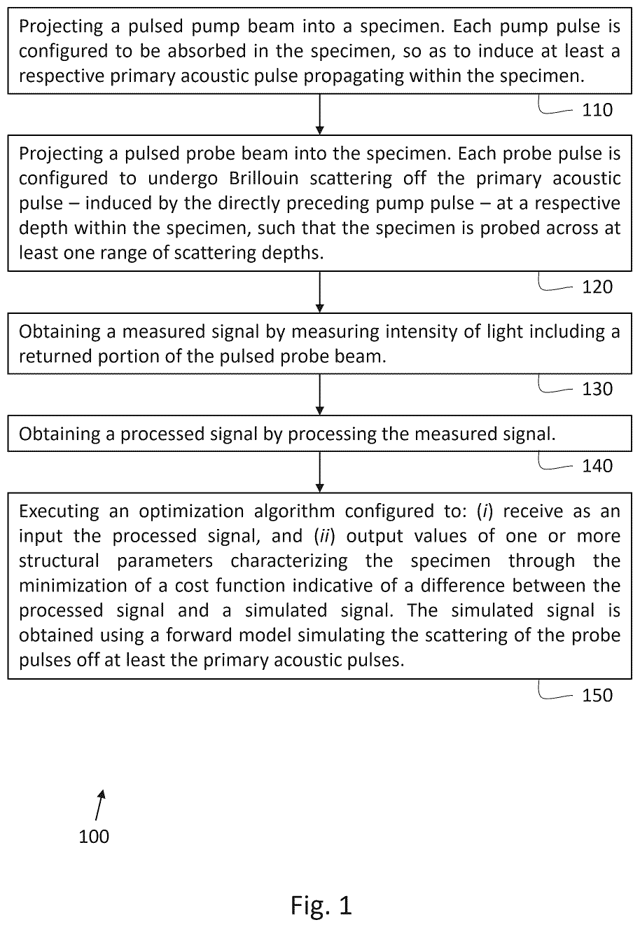

FIG. 1 presents a flowchart of a method 100 for non-destructive acousto-optic depth-metrology of structures, according to some embodiments. Method 100 includes:
An operation 110, wherein a pulsed pump beam is projected into a (profiled) specimen including a structure, which is to be tested. Each of the pump pulses in the pulsed pump beam is configured to be absorbed in the specimen, so as to induce formation of at least a respective primary acoustic pulse propagating within the tested structure.
An operation 120, wherein a pulsed probe beam is projected into the specimen. Each probe pulse in the probe beam is configured to undergo Brillouin scattering off the primary acoustic pulse, which is induced by the respective pump pulse directly preceding the probe pulse, at a respective depth within the specimen, such that the specimen is probed across at least one range of depths.
An operation 130, wherein a measured signal is obtained by measuring an intensity of light, which includes a portion of the pulsed probe beam returned from the specimen.
An operation 140, wherein the measured signal is subject to processing to obtain a processed signal.
An operation 150, wherein an optimization algorithm is executed. The optimization algorithm is configured to (i) receive as an input at least the processed signal, and (ii) output a set of structural parameters characterizing the tested structure through the minimization of a cost function indicative of a difference between the processed signal, and a simulated signal. The simulated signal is obtained using a forward model simulating the scattering of the probe pulses off at least the primary acoustic pulses within the tested structure.

In each iteration thereof the optimization algorithm updates a guesstimate of the set of structural parameters, and based thereon, the simulated signal.

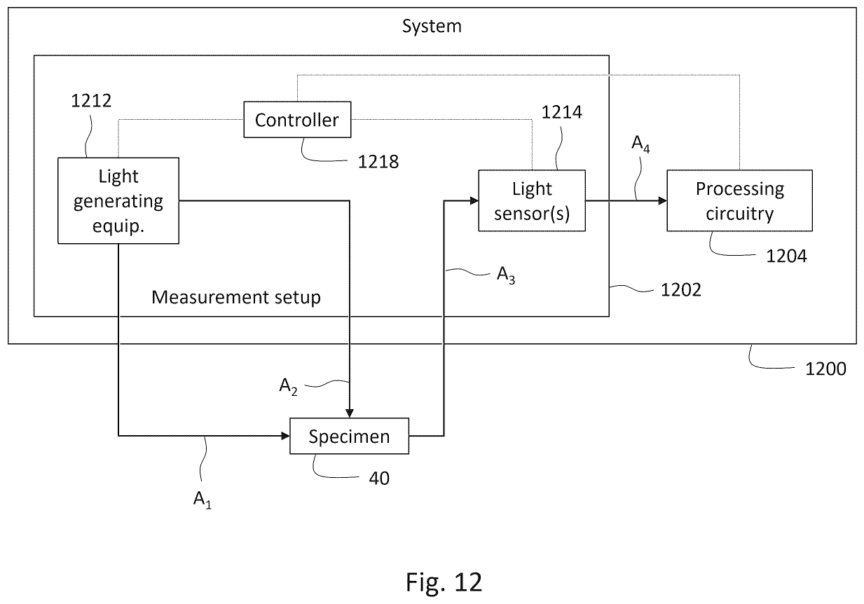

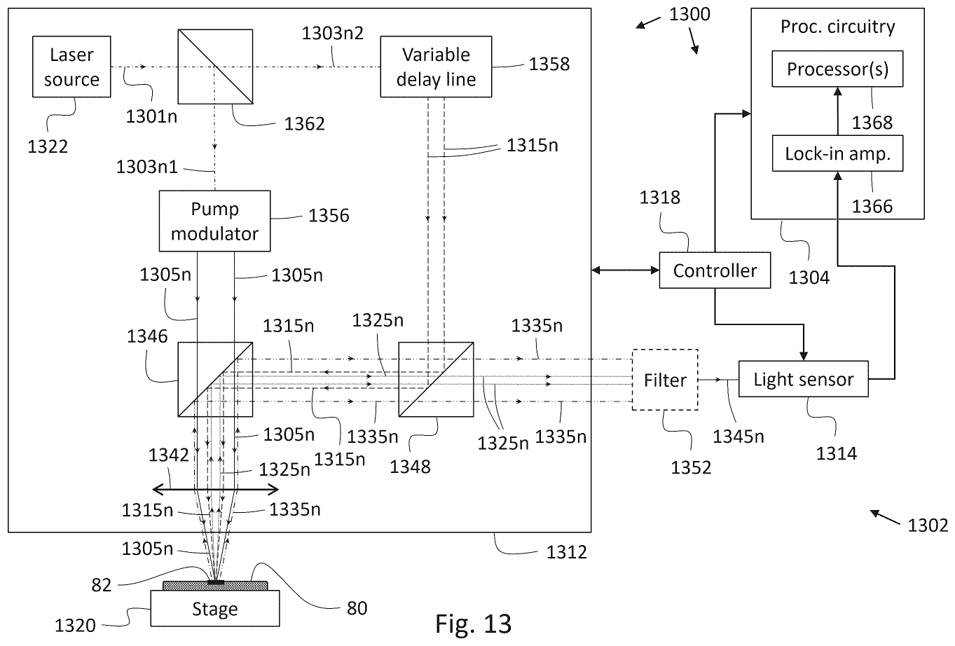

Method 100 may be implemented using any one of the systems described below in the descriptions of FIGS. 12 and 13, or systems similar thereto.

According to some embodiments, the tested structure is or includes one or more semiconductor materials. According to some embodiments, the tested structure is disposed on a bulk (e.g. a silicon bulk). According to some embodiments, the specimen is a patterned wafer, e.g. in one of the fabrication stages thereof, and the tested structure is embedded on the wafer.

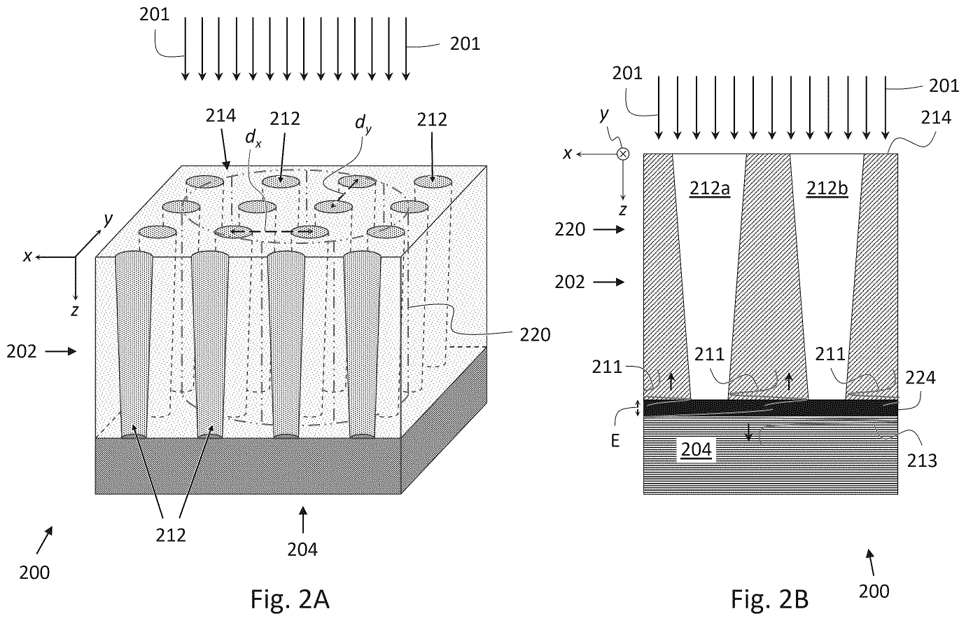

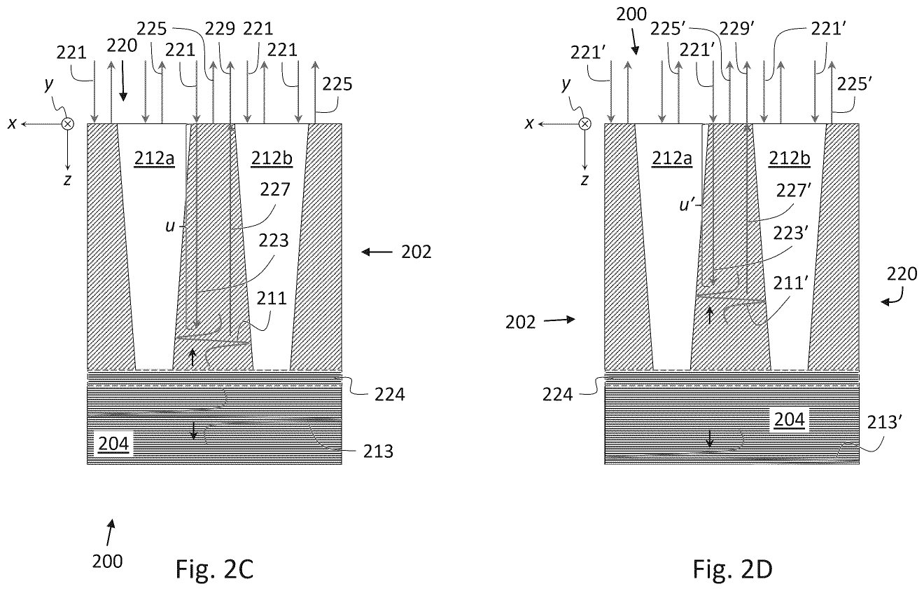

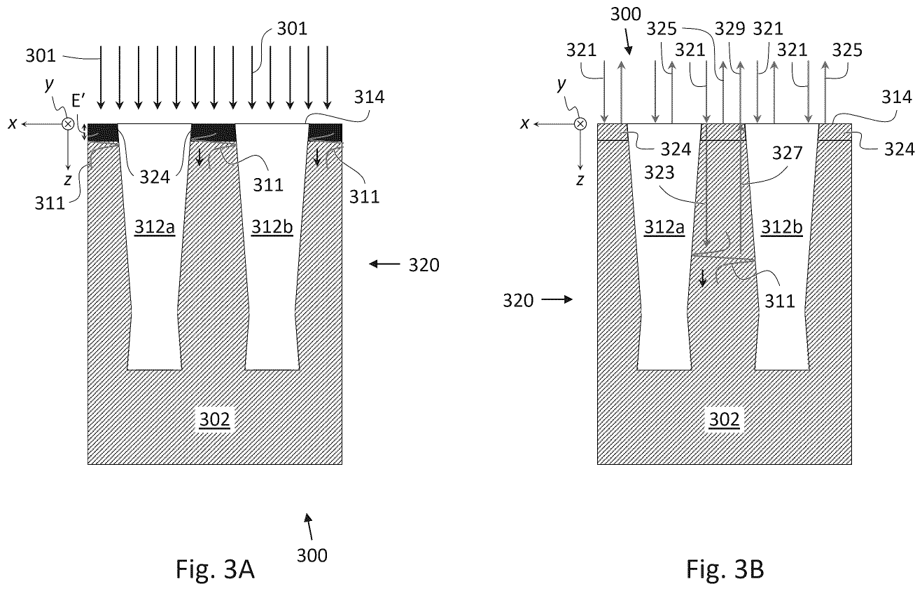

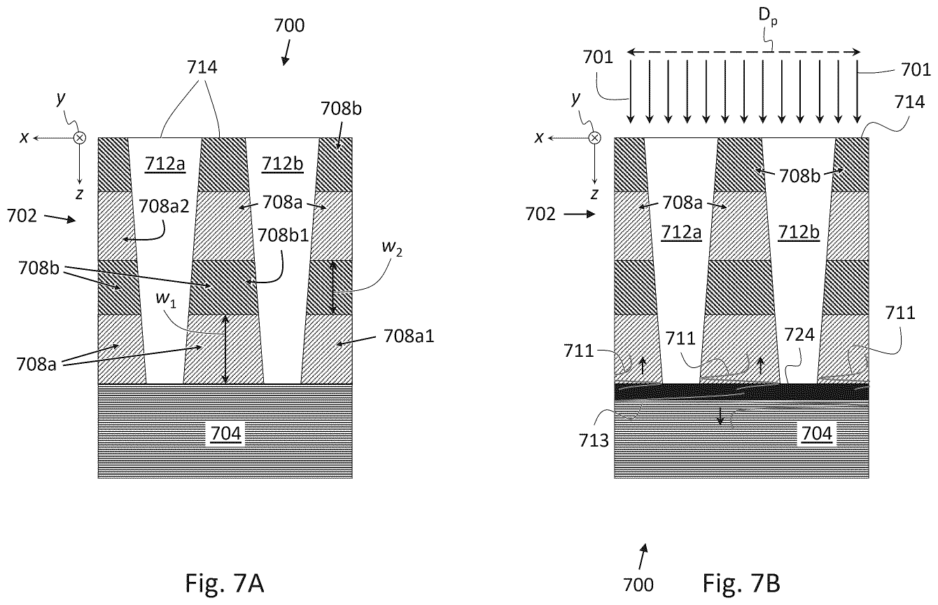

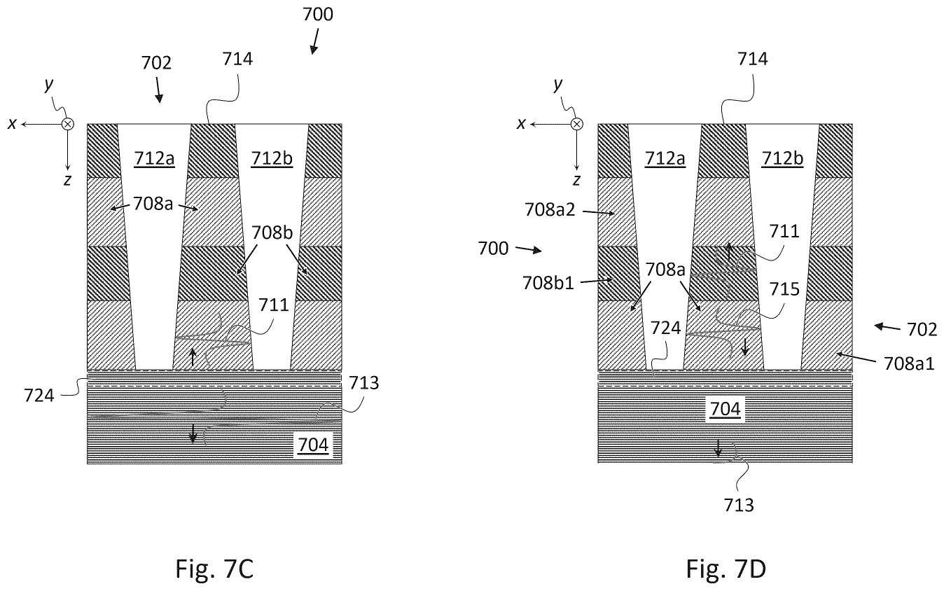

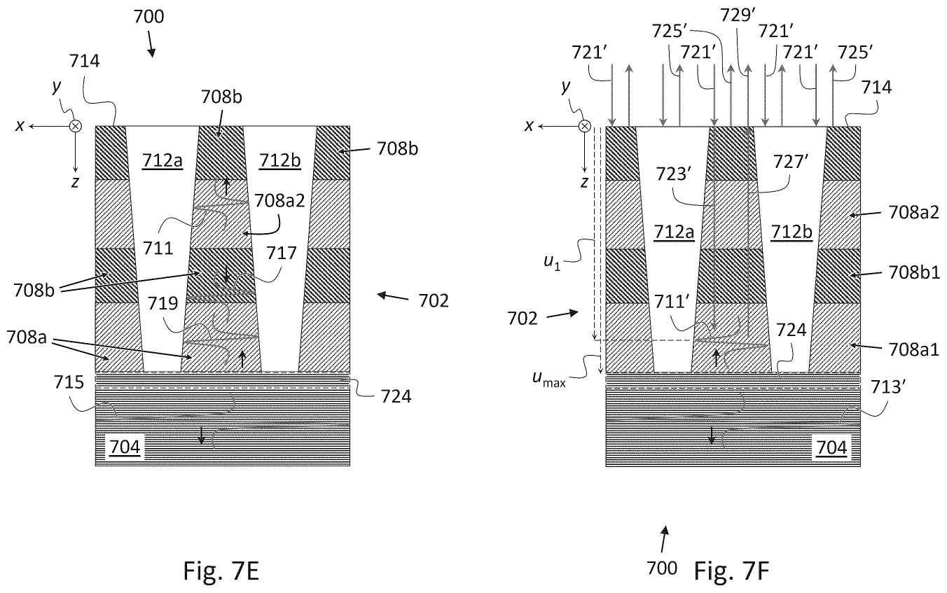

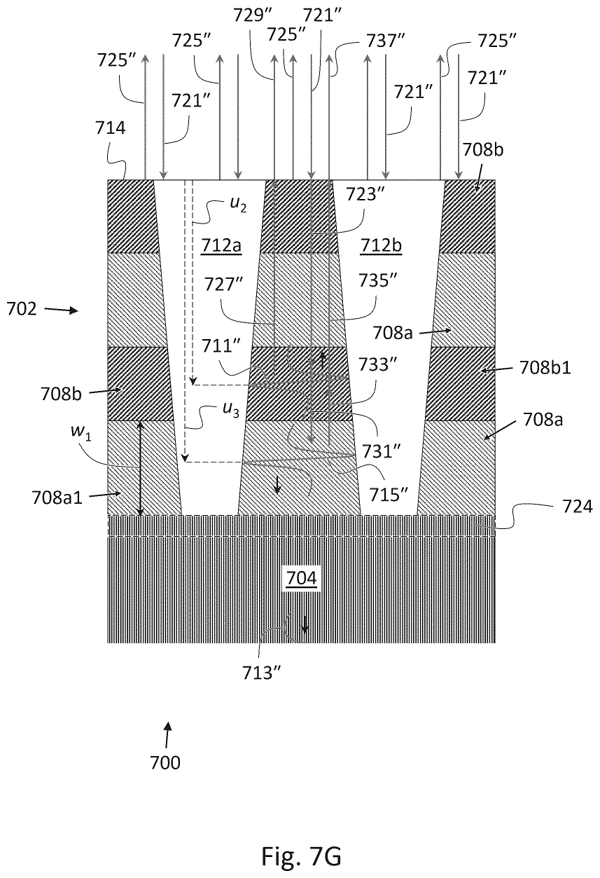

According to some embodiments, each of the pump pulses is configured to be absorbed in a slice (referred to as “absorbing slice”) of the specimen, so that the respectively induced primary acoustic pulse propagates within the specimen away from the absorbing slice. According to some embodiments, and as depicted, for example, in FIG. 2B and in FIG. 7B, the absorbing slice may be embedded in the specimen. Non-limiting examples include embodiments wherein the specimen includes a semiconductor structure (i.e. the tested structure), which is mounted on a bulk (e.g. a silicon bulk) with the absorbing slice constituting a thin layer within the bulk. The absorbing slice may be adjacent to the semiconductor structure. According to some embodiments, and as depicted in FIG. 3A, the absorbing slice may be exposed on top of the tested structure: Non-limiting examples include embodiments wherein the tested structure is made of silicon (Si) or silicon germanium (SiGe).

According to some embodiments, the tested structure may include vias extending into the tested structure from a top surface of the specimen. The set of structural parameters may characterize at least a mean geometry of the vias. According to some embodiments, the depth of the vias may be at least about 1 μm.

The term “set” is to be understood as covering not only multi-element sets (e.g. including a plurality of structural parameters) but also single element sets. An element of a set may represent a datum (e.g. a value of a structural parameter) or data (e.g. values of a plurality of structural parameters). A pertinent example of the latter case is when an element of a set (e.g. a set of structural parameters pertaining to a tested structure) represents a function (e.g. the mean lateral cross-sectional area of vias as a function of the depth within a tested structure). According to some embodiments, the set of structural parameters may include one or more functions specifying the dependence on the depth within the tested structure of one or more physical characteristics, respectively, of the tested structure. As a non-limiting example, in embodiments wherein the tested structure includes vias, the one or more physical characteristics may include the mean (averaged with respect to the vias) area of the lateral cross-section of the vias. Optionally, the one or more physical characteristics may additionally include one or more parameters (beyond the mean area) specifying the mean shape of the lateral cross-section of the vias (e.g. the magnitudes of the axes of an ellipse when the lateral cross-section of the vias is predetermined, or otherwise known, to be substantially elliptical). According to some embodiments, wherein the lateral cross-section of the vias is predetermined, or otherwise known, to be substantially circular, the one or more physical characteristics may be constituted by the mean diameter of the vias.

According to some embodiments, the pump beam is a laser beam. Selectable parameters of the pump beam may include one or more of a frequency of the pump pulses, the number of pump pulses, a duration of each pump pulse, a duration of the pump beam, a time interval between succeeding pump pulses, a modulation frequency of the pump beam, and a polarization of the pump beam. In particular, in embodiments wherein the absorbing slice is buried and is not exposed, parameters of the pump beam may be selected to ensure that in operation 110 the pump beam is absorbed substantially only in the absorbing slice. To this end, the frequency of the pump beam—and, optionally, according to some embodiments, the polarization of the pump beam—may be selected such that the pump beam is substantially transparent with respect to matter located between the top of the tested structure and the absorbing slice. According to some embodiments, the wavelength of the pump pulses may be in the ultraviolet light range.

According to some embodiments, the probe beam is a laser beam. Selectable parameters of the probe beam may include one or more of a frequency of the probe pulses, the number of probe pulses, a duration of each probe pulse, a polarization of the probe beam, and a time interval between succeeding probe pulses. The duration of each probe pulse may be selected to be shorter than the characteristic time scale of the thermo-optic effect and the periods of the acoustic pulses (or, more precisely, the periods of the higher frequency components of the acoustic pulses). According to some such embodiments, a duration of each of the pump pulses and/or the probe pulses is shorter than 10 psec. According to some embodiments, the wavelength of the probe pulses may be selected to be in the visible light range or the infrared light range.

According to some embodiments, the pump beam and the probe beam may be prepared using the same laser source, e.g. with a beam splitter being used to split the initial laser beam (e.g. a pulsed laser beam) into the pump beam and the probe beam. According to some such embodiments, the pump beam may be amplitude-modulated to facilitate isolating a contribution to the measured signal of the returned portion of the probe beam. The modulation frequency may be smaller than the bandwidth of the light sensor. According to some embodiments, the modulation frequency may be in the 0.1 MHz to 10 MHz range.

According to some embodiments, the pump beam may have a different wavelength than the probe beam. These include some embodiments wherein the pump beam and the probe beam are prepared using the same laser source: As a non-limiting example, following passage through a beam splitter, a harmonic generation unit and an optical filter may be employed to alter the frequency of one of the two beams exiting the beam splitter from the fundamental frequency (i.e. defined by the output of the laser source) to one of the higher harmonics thereof. According to some embodiments, wherein the pump beam is amplitude modulated, the carriers of the pump pulses may have a different wavelength than the probe pulses. According to some such embodiments, in obtaining the measured signal, an optical filter may be used to filter out a returned component of the pump beam (while passing through the optical filter a returned component of the probe beam). Additionally, or alternatively, following demodulation of the measured signal (as described below), depending on whether the pump beam is of a higher or lower frequency than the probe beam, a low or high pass filter may be used to remove the contribution to the demodulated signal of the returned component of the pump beam.

According to some embodiments, the measured signal of operation 130 is constituted by a sequence of measured intensities. The number of measured intensities in the sequence may depend on the bandwidth B of the light sensor used to implement operation 130 and the duration of the projected beams (i.e. the pump beam and the probe beam). According to some such embodiments, the rate of the probe pulses may be greater than the bandwidth of a light sensor used in operation 130 to obtain the measured signal. Accordingly, in such embodiments, each of the measured intensity values (making up the measured signal) will include contributions from the returned portions of each of a plurality of consecutively projected probe pulses within a time interval equal to 1/B. Put differently, following demodulation and cleaning of the measured signal to isolate the contribution thereto of the induced Brillouin oscillations, each of the resulting processed intensity values will correspond to an average over the contributions of each in a respective plurality of returned portions, which is incident on the light sensor within a time interval equal to 1/B. Such averaging may potentially reduce the signal-to-noise ratio.

According to some embodiments, wherein the tested structure includes vias (vertically extending holes) arranged in a two-dimensional array, the pulsed probe beam may be linearly polarized along a lateral direction, which is perpendicular to the longitudinal dimension of the vias. More specifically, according to some embodiments, wherein the vias are arranged in a rectangular array (e.g. as depicted in FIGS. 2A), in order to increase measurement sensitivity along a first lateral direction (e.g. along the y-axis in FIG. 2A), the pulsed probe beam may be polarized along a second lateral direction (e.g. along the x-axis in FIG. 2A), which is perpendicular to the first lateral direction. The first lateral direction extends in parallel to the direction along which the columns of the rectangular array are arranged. The second lateral direction extends in parallel to the direction along which the rows of the rectangular array are arranged. Similarly, in order to increase the measurement sensitivity along the second lateral direction, the pulsed probe beam may be polarized along the first lateral direction. Polarizing a probe pulse in parallel to the first lateral direction may lead to a non-uniform intensity distribution of the probe pulse within the probed portion, wherein the intensity is maximum along rows of vias. In contrast, polarizing a probe pulse in parallel the second lateral direction may lead to a non-uniform intensity distribution of the probe pulse within the probed portion, wherein the intensity is maximum along columns of vias.

To facilitate the description by way of a non-limiting example, reference is additionally made to FIGS. 2A-2D. FIG. 2A provides a perspective partial view of a (profiled) specimen 200 with a front part thereof removed to reveal the internal structure of specimen 200. Specimen 200 includes a tested structure 202 (e.g. a semiconductor structure) and a bulk 204 (e.g. a silicon substrate). Tested structure 202 is positioned on top of bulk 204. According to some embodiments, and as depicted in FIGS. 2A-2D, tested structure 202 is shown as including vias 212 (e.g. empty holes), which extend into tested structure 202 from a top surface 214 of tested structure 202. As a non-limiting example, each of vias 212 is assumed to extend longitudinally (and vertically) into tested structure 202 and to have a circular lateral cross-section whose area decreases with the depth. According to some embodiments, and as depicted in FIG. 2A, vias 212 may be arranged in a periodic two-dimensional array. According to some such embodiments, the two-dimensional array is rectangular with vias 212 being arranged in rows and columns parallel to two orthogonal axes, respectively (e.g. the x-axis and the y-axis, respectively, per the coordinate system depicted in FIG. 2A).

Referring also to FIGS. 2B-2D, FIGS. 2A-2D schematically depict stages in an application of method 100, according to some embodiments thereof, to tested structure 202, or, more precisely, a (probed) portion 220 (indicated in FIG. 2A and delineated by a dashed-double-dotted line) of tested structure 202. Probed portion 220 may be shaped as a cylinder whose diameter is defined by the beam diameter of the pump beam projected on top surface 214 in operation 110. In order to fully probe probed portion 220, the beam diameter of the probe beam may be selected in operation 120 to at least equal, or substantially equal, the beam diameter of the pump beam. According to some embodiments, and as depicted in FIG. 2A, probed portion 220 includes a plurality of vias from vias 212.

FIGS. 2A and 2B show a pump pulse 201 projected on top surface 214, according to some embodiments. Pump pulse 201 forms part of a pulsed pump beam, which is projected on tested structure 202 in accordance with operation 110. Pump pulse 201 is configured to penetrate into tested structure 202 and propagate therein onto bulk 204. Pump pulse 201 is further configured to be absorbed by bulk 204. A slice 224 (also referred to as “absorbing slice”) indicates a segment within bulk 204 in which substantially all of pump pulse 201—or substantially all of the transmitted portion of pump pulse 201 in embodiments wherein a non-negligible portion of pump pulse 201 is reflected off bulk 204—has been absorbed. Absorbing slice 224 is adjacent to tested structure 202. A thickness of absorbing slice 224 depends on the absorption length of pump pulse 201 in bulk 204.

The absorption of pump pulse 201 by absorbing slice 224 leads to the heating of absorbing slice 224. The heating of absorbing slice 224 leads to an expansion thereof, as indicated by a double-headed arrow E. The expansion of absorbing slice 224 leads to the formation of a primary acoustic pulse 211, and an additional acoustic pulse 213, each propagating away from absorbing slice 224. Primary acoustic pulse 211 propagates within tested structure 202 in the direction of the negative z-axis (i.e. towards top surface 214). As primary acoustic pulse 211 propagates within tested structure 202, the local mass density, whereat primary acoustic pulse 211 is momentarily localized, is temporarily modified. This temporary modification of the density leads to a corresponding temporary (local) modification of the refractive index due to the elasto-optic effect. Additional acoustic pulse 213 may propagate within bulk 204 in the direction of the positive z-axis.

FIG. 2C depicts a cross-sectional view of probed portion 220 at a later time as compared to FIG. 2B. Absorbing slice 224 has cooled down and accordingly is no longer colored in black. Each of primary acoustic pulse 211 and additional acoustic pulse 213 has propagated away from absorbing slice 224. A probe pulse 221 is shown projected on top surface 214, according to some embodiments. Probe pulse 221 forms part of a pulsed probe beam, which is projected on tested structure 202 in accordance with operation 120. In particular, the pulsed probe beam and the pulsed pump beam (in which pump pulse 201 is included) may be prepared using the same laser source, as described above. From optical diffraction limit considerations, according to some embodiments, a wavelength of probe pulse 221 may be at least about two times greater than a distance between adjacent vias (from vias 212, such as a first via 212a and a second via 212b). A transmitted portion 223 of probe pulse 221 penetrates tested structure 202. A reflected portion 225 of probe pulse 221 is reflected off top surface 214. Transmitted portion 223 travels in the direction of bulk 204 and is Brillouin scattered-off primary acoustic pulse 211, as indicated in FIG. 2C by a scattered portion 227. A transmitted portion 229 corresponds to the part of scattered portion 227 transmitted out of tested structure 202 through top surface 214.

As used herein, the terms “reflection” and “transmission” are to be understood as encompassing partial reflection and partial transmission, respectively.

In order not to encumber FIG. 2C, primary acoustic pulse 211 is rendered only between first via 212a and second via 212b. However, it is to be understood that the lateral extent of primary acoustic pulse 211 is not so limited and propagation thereof occurs throughout all of probed portion 220. Similarly, the arrows representing transmitted portion 223, scattered portion 227, and transmitted portion 229 are rendered only between first via 212a and second via 212b. However, it is to be understood that the lateral extents of transmitted portion 223, scattered portion 227, and transmitted portion 229 are not so limited and propagation thereof occurs throughout all of probed portion 220.

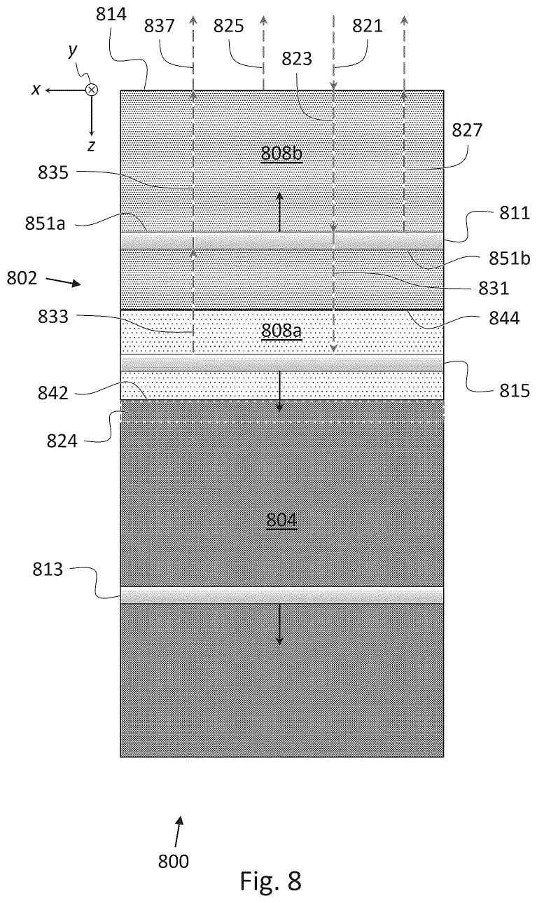

The depth within tested structure 202 at which transmitted portion 223 is (Brillouin) scattered off primary acoustic pulse 211 depends on the time delay by which probe pulse 221 is delayed relative to the preceding pump pulse (i.e. pump pulse 201). More precisely, the depth u (i.e. the vertical distance from top surface 214) at which probe pulse 221 is Brillouin scattered off primary acoustic pulse 211 is related to the time delay via Δt≈T_{F}+(uₘₐₓ−u)/v. T_{F} is the formation time of primary acoustic pulse 211. uₘₐₓ is the distance from top surface 214 to bulk 204. (Generally, z=u+a, wherein a is a constant. If the coordinate system is selected such that the xy-plane coincides with top surface 214, then a=0 and z=u.) v designates the speed of sound in tested structure 202. Here, as a non-limiting example, it is assumed that, apart from the presence of vias 212, tested structure 202 is uniform, so that the speed of sound therein does not vary with the depth. The more general case is addressed below in the description of the method of FIG. 8.

According to some embodiments, the pump pulses and the probe pulses may be alternately projected on probed portion 220, such that for each k the k-th probe pulse is projected after the k-th pump pulse and before the (k+1)-th probe pulse. Further, each of the probe pulses may be delayed by a respective time interval relative to the directly preceding pump pulse, which is varied from one pair of probe-pump pulses to the next, so as to facilitate probing the tested specimen across at least one range of depths. In particular, in such embodiments, each of the probe pulses “probes” the tested structure at a respective depth.

FIG. 2D depicts a cross-sectional view of probed portion 220 following the projection thereon, in accordance with operation 110, of a later pump pulse (not shown), which may be included in the same pulsed pump beam as pump pulse 201. The later pump pulse is subsequent to pump pulse 201. Pump pulse 201 and the later pump pulse may or may not be consecutive. The later pump pulse is absorbed in absorbing slice 224 leading to the heating thereof and formation of a primary acoustic pulse 211′ and an additional acoustic pulse 213′ propagating away from the absorbing slice within tested structure 202 and bulk 204, respectively, as described above in the description of FIG. 2B.

A probe pulse 221′ is shown projected on top surface 214 in accordance with operation 120. Probe pulse 221′ may be included in the same pulsed probe beam as probe pulse 221. A transmitted portion 223′ of probe pulse 221′ penetrates tested structure 202 into probed portion 220. A reflected portion 225′ of probe pulse 221′ is reflected off top surface 214. Transmitted portion 223′ travels in the direction of bulk 204 and is Brillouin scattered-off primary acoustic pulse 211′, as indicated in FIG. 2D by a scattered portion 227. A transmitted portion 229′ corresponds to the part of scattered portion 227′ transmitted out of tested structure 202 through top surface 214. Probe pulse 221′ is delayed with respect to the later pump pulse by a time delay Δt′, which is greater than Δt (the time delay by which probe pulse 221 is delayed with respect to pump pulse 201). Accordingly, a depth u′, at which probe pulse 221′ is scattered off primary acoustic pulse 211′ is smaller than u (the depth at which probe pulse 221 is scattered off primary acoustic pulse 211).

In order not to encumber FIG. 2D, primary acoustic pulse 211′, as well as the arrows representing transmitted portion 223′, scattered portion 227′, and transmitted portion 229′, are rendered only between first via 212a and second via 212b. However, it is to be understood that the lateral extents of each of primary acoustic pulse 211′, transmitted portion 223′, scattered portion 227′, and transmitted portion 229′ are not so limited and propagation thereof occurs throughout all of probed portion 220.

Generally, the returned portion of a probe pulse will also include a contribution due to scattering off the acoustic pulse (e.g. additional acoustic pulses 213 and 213′ in FIGS. 2C and 2D, respectively) induced within bulk 204. The corresponding scattered portions are not shown in FIGS. 2C and 2D. These contributions may be distinguished from contributions due to scattering within tested structure 202, and, according to some embodiments, are not taken into account in determining the set of structural parameters (pertaining to tested structure 202). As a non-limiting example, the bulk may be composed of silicon and the tested structure (mounted on the bulk) may be composed of oxide. As the refractive indices of silicon and oxide in the visible-light range are approximately 4 and 1.45, respectively, and the speed of sound is about 8,400 m/sec in silicon and about 4,600 m/sec in oxide, the ratio of the Brillouin frequency of silicon to that of oxide is about 5. Accordingly, a low pass filter be employed to filter out the contribution to the measured signal (or, more precisely, the demodulated signal) induced by the scattering of acoustic pulses within the bulk.

While in FIGS. 2A-2D the diameter of vias 212 is depicted as decreasing substantially linearly with the depth, the skilled person will readily perceive that the methods and systems of the present disclosure may be applied to probe other via geometries. These include, for example, straight via geometries (i.e. via geometries wherein the diameter (or diameters when the lateral cross-section of the via is elliptical rather than circular) is constant), or via geometries wherein the change (with the increase in depth) of the via diameter(s) is non-monotonic (for example, increasing first and then decreasing e.g. as depicted in FIGS. 3A and 3B).

FIGS. 3A and 3B depict two different stages in an implementation of method 100, according to some specific embodiments thereof, to a tested structure 302 (included in a profiled specimen 300), or, more precisely, a probed portion 320 of tested structure 302. FIG. 3A provides a perspective partial view of tested structure 302 with a front part thereof removed to reveal the internal structure thereof. As a non-limiting example, tested structure 302 is shown as including vias 312 projecting into tested structure 302 from a top surface 314 of tested structure 302. According to some embodiments, and as depicted in FIGS. 3A and 3B, tested structure 302 is similar to tested structure 202 but may differ therefrom, for example, in material composition and/or in the depth of vias 312. According to some embodiments, tested structure 302 may be of uniform composition (up to the presence of vias 312), e.g. being made of silicon (Si) or silicon germanium (SiGe).

A pump pulse 301 is shown projected on top surface 314 in FIG. 3A, according to some embodiments. Pump pulse 301 forms part of a pulsed pump beam, which is projected on tested structure 302 in accordance with operation 110. Pump pulse 301 is configured to be absorbed by tested structure 302. In embodiments wherein, as depicted in FIGS. 3A and 3B, tested structure 302 is made of a single material, a wavelength of pump pulse 301 may be selected such that, for this wavelength, the absorbance coefficient of tested structure 302 is high. In embodiments (not depicted in FIGS. 3A and 3B) wherein tested structure 302 is layered, a wavelength of pump pulse 301 may be selected such that, for this wavelength, the absorbance coefficient of the top layer of tested structure 302 is high. Accordingly, pump pulse 301 is absorbed in a top slice 324 (referred to as “absorbing slice”) of tested structure 302. A top surface of absorbing slice 324 is constituted by top surface 314. A thickness of absorbing slice 324 depends on the absorption length of pump pulse 301 in tested structure 302 or the top layer of tested structure 302 in embodiments wherein tested structure 302 is layered.

The absorption of pump pulse 301 by absorbing slice 324 leads to the heating of absorbing slice 324, which, in turn, leads to an expansion thereof, as indicated by a double-headed arrow E′. The expansion of absorbing slice 324 leads to the formation of a (primary) acoustic pulse 311 propagating in the direction of the (positive) z-axis. As acoustic pulse 311 propagates within tested structure 302, the local mass density, whereat acoustic pulse 311 is momentarily localized, is temporarily modified. This temporary modification of the density leads to a corresponding temporary (local) modification of the refractive index due to the elasto-optic effect.

FIG. 3B depicts a cross-sectional view of tested structure 302 at a later time as compared to FIG. 3A. Absorbing slice 324 has cooled down and accordingly is no longer colored in black. Acoustic pulse 311 has propagated away from absorbing slice 324. A probe pulse 321 is shown projected on top surface 314, according to some embodiments. Probe pulse 321 forms part of a pulsed probe beam, which is projected on tested structure 302 in accordance with operation 120. In particular, the pulsed probe beam and the pulsed pump beam may be prepared using the same laser source, as described above. From optical diffraction limit considerations, according to some embodiments, a wavelength of probe pulse 321 may be at least about two times greater than a distance between adjacent vias (from vias 312, such as a first via 312a and a second via 312b). A transmitted portion 323 of probe pulse 321 penetrates tested structure 302. A reflected portion 325 of probe pulse 321 is reflected off top surface 314. Transmitted portion 323 is Brillouin scattered off acoustic pulse 311, as indicated in FIG. 3B by a scattered portion 327. A transmitted portion 329 corresponds to the part of scattered portion 327 transmitted out of tested structure 302 through top surface 314.

In order not to encumber FIG. 3B, acoustic pulse 311, as well as the arrows representing transmitted portion 323, scattered portion 327, and transmitted portion 329, are rendered only between first via 312a and second via 312b. However, it is to be understood that the lateral extents of each of acoustic pulse 311, transmitted portion 323, scattered portion 327, and transmitted portion 329 are not so limited and propagation thereof occurs throughout all of probed portion 320.

The depth within tested structure 302 at which transmitted portion 323 is (Brillouin) scattered off acoustic pulse 311 depends on the time delay by which probe pulse 321 is delayed relative to the preceding pump pulse. More precisely, the depth u at which transmitted portion 323 is Brillouin scattered off acoustic pulse 311 is related to the time delay via Δt≈T_{F}+u/v. Here, as a non-limiting example, it is assumed that, apart from the presence of vias 312, tested structure 302 is uniform, so that the speed of sound therein does not vary with the depth.

According to some embodiments, the pump pulses and the probe pulses may be alternately projected on tested structure 302, essentially as described above in the description of specimen 200.

While in FIGS. 3A and 3B the diameter of vias 312 is depicted as first decreasing and then increasing with the depth, the skilled person readily perceive that the methods and systems of the present disclosure may be applied to probe other via geometries, such as, for example, straight via geometries or via geometries as depicted in FIGS. 2A-2D.

Generally, the frequency of a returned portion (e.g. transmitted portion 229 or 329) of a probe pulse (e.g. probe pulse 221 or probe pulse 321), which exits a tested structure following Brillouin scattering therein, will differ from that of the directly reflected portion (e.g. reflected portion 225 or 325) of the probe pulse. This so-called “Brillouin frequency shift” (also referred to simply as “Brillouin frequency”) depends on the local refractive index (or local effective refractive index, e.g. when the tested structure includes vias) and the local speed of sound within the tested structure, as well as the frequency (or, equivalently, the wavelength) of the probe pulse. The Brillouin frequency shift is manifested as an oscillating contribution (termed “Brillouin oscillations”) to the returned portion of a probe beam due to interference of the Brillouin scattered portion of the probe beam—or each of the Brillouin scattered portions of the probe beam, e.g. when the tested structure is layered—with a reflected portion of the probe beam. Here by “reflected portion of the probe beam” what is meant is the part of the probe beam, which is reflected off the tested structure (e.g. off the top surface thereof) without being transmitted thereinto (i.e. without entering the tested structure). Accordingly, by measuring the Brillouin frequency shift, localized information regarding the geometry and material composition of a tested structure may be derived. According to some embodiments, additional information may be derived from other parameters characterizing the induced Brillouin oscillations (e.g. the amplitude thereof).

According to some embodiments, in order to fully probe a tested structure, operations 110-130 may be sequentially implemented with respect to each of a plurality of probed portions (such as probed portion 220). According to some embodiments, measurement data of each probed portion may be processed alone, so that the obtained set of structural parameters pertains solely to the probed portion. Alternatively, according to some embodiments, measurement data from each of the plurality of probed portions may be jointly processed. According to some such embodiments, some or all of the key parameters may be derived taking into account the measured signals from all of the probed portions from the plurality of probed portions. In some such embodiments, wherein the probed portions are nominally identical, the obtained set of structural parameters may correspond to averages over the structural parameters pertaining to each of the probed portions from the plurality of probed portions.

Referring to operation 140, according to some embodiments, the derivation of the processed signal may involve the extraction from the measured signal of key parameters characterizing the induced Brillouin oscillations, and, more specifically, the dependence of at least some of these key parameters on the time delay (or, equivalently, the Brillouin scattering depth). In particular, the derivation may involve extracting the dependence of the Brillouin frequency shift on the time delay. According to some embodiments, operation 140 may include an initial suboperation, wherein the measured signal is converted into a digital signal (e.g. using an analog-to-digital converter).

According to some embodiments, the pulsed pump beam (of operation 110) may be modulated so as to facilitate substantial removal, or at least reduction, of noise and background signals from the measured signal, and thereby isolate a contribution of the Brillouin oscillations to the measured signal. More specifically, according to some such embodiments, and as described in more detail below, a lock-in amplifier may be used in operation 140 to demodulate the measured signal and thereby isolate the Brillouin oscillations contribution. In particular, the key parameters may be extracted following the demodulation.

According to some embodiments, operation 140 may further include, following the demodulation, one or more of: (i) removal or at least attenuation of a thermo-optic contribution to the measured signal, as described in detail below in the Systems subsection, (ii) laser noise reduction (e.g. using a reference channel), and (iii) selective filtering out of undesired ranges in the Fourier transform of the demodulated signal, as well as, optionally, other digital signal processing operations such as the extraction from the demodulated signal of a spectrogram.

The forward model is configured to receive as inputs a set of structural parameters and output a corresponding simulated signal. The simulated signal is intended to simulate the processed signal of operation 140. (i.e. when the input set of structural parameters matches the GT data). According to some such embodiments, the simulated signal may specify simulated values of key parameters. According to some embodiments, the forward model of operation 150 may be or incorporate a computer simulation, which simulates Brillouin scattering of probe pulses off acoustic pulses within tested structures.

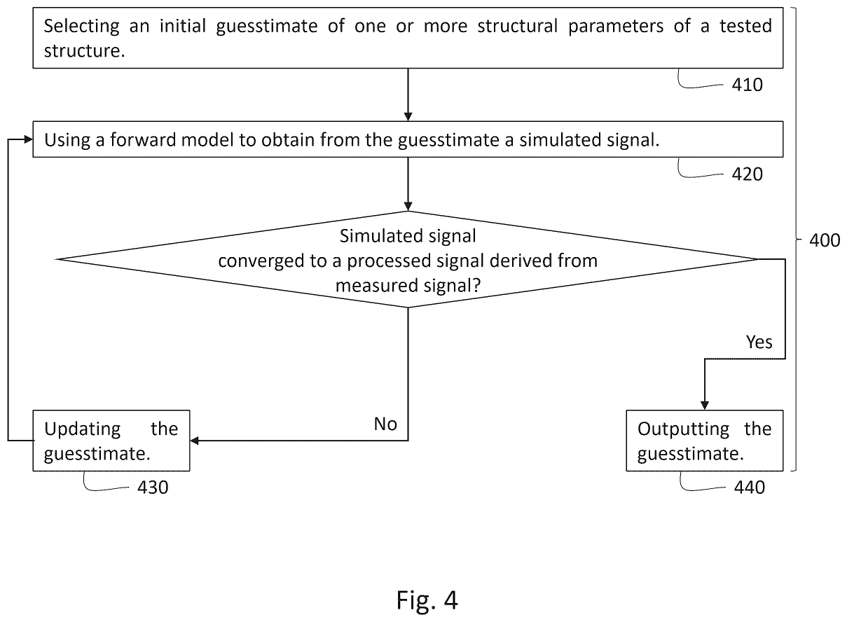

More precisely, the structural parameters, which the forward model is configured to receive in each of the iterations of the optimization algorithm, may be constituted by, or at least include the structural parameters, which are to be determined by method 100. In contrast to these structural parameters (i.e. which may be fed as inputs to the forward model in each of the iterations), other structural parameters may be fixed (e.g. defined by the user based on design data and/or GT data). According to some embodiments, the values of these (fixed) structural parameters may be initially set—i.e. input into the forward model prior to the first iteration—without subsequently being updated. Other (physical) parameters of the forward model may also be initially known or known to a sufficiently high accuracy, and therefore not updated from one iteration to the next. Referring to these non-updated parameters of the forward model as “fixed parameters”, according to some embodiments, the fixed parameters may include some or all of the following: (i) when the profiled specimen includes vias, the mean pitches (i.e. the mean distances between centers of adjacent vias), (ii) when the profiled specimen is layered, the thicknesses and/or material compositions of the layers, (iii) the die lattice geometry (e.g. rectangular, hexagonal), (iv) the values of refractive indices of, and/or speeds of sound in, various materials included in the tested structure, (v) the transmission and reflection coefficients characterizing the boundaries between adjacent layers (when the profiled specimen is layered), (vi) the wavelengths, intensities, and/or durations of the pump and probe pulses, and/or the time delays between successive pulses, (vii) the focus of the pump beam and/or the focus of the probe beam, (viii) when polarized, the polarizations of the pump beam and the probe beam, (ix) the location(s) on the profiled specimen at which the pump beam and/or the probe beam impinges, and (x) parameters characterizing the measurement setup (e.g. the bandwidth and/or gain of the light sensor). According to some embodiments, and as elaborated on below in the description of FIG. 4, values of some or all of the non-fixed parameters of the forward model, including, optionally, the structural parameters to be determined, may be constrained to within respective ranges of values.

According to some embodiments, the values of some of the fixed parameters may be determined in a calibration operation, which is implemented prior to operation 140 or, optionally, prior to operation 130, as described below. According to some such embodiments, one or more of the fixed parameters may specify values of parameters parameterizing the simulated signal.

According to some embodiments, wherein the forward model is or incorporates a computer simulation, the computer simulation may be configured to: (i) initially receive parameters characterizing each of a probe pulse, which is incident on a tested structure, and an acoustic pulse(s) propagating within the tested structure (including parameters specifying a location of the acoustic pulse within the tested structure e.g. at the time the probe pulse strikes the tested structure), and (ii) output at least a Brillouin frequency shift characterizing the induced Brillouin oscillations. More generally, the computer simulation may be configured to output a plurality of key parameters characterizing the Brillouin oscillations or at least some of the Brillouin oscillations. Parameters characterizing the probe pulse and the acoustic pulse(s) are selectable so as to at least allow simulating the probing of a tested structure at each of a plurality of depths in accordance with method 100 prescription. Additional selectable parameters may include, for example, the wavelength and duration of the probe pulse, and the phase of the returned component of a probe pulse. According to some embodiments, the values of some of the selectable parameters are determined in real-time (e.g. prior to operation 150), based on the processed signal, using machine learning tools. As a non-limiting example, the decay response of the envelope of the processed signal may be determined in real-time using machine learning tools.

Parameters characterizing the tested structure, specifying the intended geometry and material composition thereof (and therefore the refractive index and the speed of sound or refractive indices and/or speeds of sound when layered), may also be selectable, at least to within respective ranges. More specifically, each structural parameter may be selectable to within a respective range, which reflects deviations, e.g. due to manufacturing imperfections, from an intended value (e.g. as specified by design data of the tested structure) of the structural parameter.

According to some alternative embodiments, wherein the forward model is or incorporates a computer simulation, the computer simulation may be configured to additionally receive as inputs parameters characterizing a pump pulse and a probe pulse. In such embodiments, the computer simulation additionally simulates the formation of the acoustic pulse(s). Parameters of the pump pulse (e.g. the wavelength and duration thereof) may be selectable, as well as the time interval by which the probe pulse is delayed relative to the pump pulse. According to some embodiments, the computer simulation may be configured to receive as inputs parameters characterizing a pulsed pump beam and a pulsed probe beam, in which case, the computer simulation additionally simulates the formation of the acoustic pulses resulting from each of the pump pulses in the pulsed pump beam.

The forward model may be derived taking into account reference data pertaining to the profiled specimen. The reference data may include one or more of design data (e.g. a computer aided design (CAD) model) of the specimen, ground truth (GT) data of specimens (referred to as “GT specimens”) of a same, and/or a similar, design intent as the profiled specimen. The GT data may be obtained by subjecting the GT specimens to destructive measurements. Non-limiting examples of pertinent destructive measurement techniques include employing transmission electron microscopy (TEM) to lamellas extracted from the GT specimens and/or slices shaved thereof (e.g. using a focused ion beam). Most generally, the reference data may refer to any information indicative of the internal geometry and material composition of the profiled specimen. According to some embodiments, the forward model may be derived additionally taking into account associated measurement data (i.e. measurement data associated with the GT data) obtained by implementing operations 110-130 with respect to specimens (constituted by, or including, the GT specimens) of a same, and/or a similar, design intent as the profiled specimen. In embodiments wherein the GT specimens include GT specimens of different design intent than the profiled specimen, the derivation of the forward model may include interpolation from the GT data, and the associated measurement data, pertaining to these GT specimens (i.e. of different design intent than the profiled specimen). According to some such embodiments, the interpolation may involve application of a k-nearest neighbor (k-NN) algorithm.

According to some embodiments, in the forward model, a tested structure, which includes vertically extending vias, is modelled by a laterally uniform structure whose refractive index is equal to n_{eff}(z)—the effective refractive index of the tested structure as estimated prior to implementing method 100 (with respect to the tested structure) based on a model of the tested structure. The model may be constructed using the reference data available prior to implementing method 100. According to some embodiments, n_{eff}(z) equals the mean refractive index as obtained by averaging over a lateral cross-section of the model at the vertical coordinate z (which quantifies the depth). That is,

$${n}_{eff} ( z ) = \frac{1}{{d}_{r} {d}_{c}} [ {A}_{via} ( z ) \cdot {n}_{0} + ( {d}_{r} \cdot {d}_{c} - {A}_{via} ( z ) ) {n}_{1} ( z ) ] , \qquad Eq . ( 1 ) .$$

n₀ is the refractive index of air or vacuum. n₁(z) is the refractive index of the material present at the z (i.e. excluding the air when operating in non-vacuum conditions). It is noted that, most generally, n₁(z) depends on z, for example, in embodiments wherein the tested structure is layered, and/or wherein the density of the material, or one or more constituents thereof, varies with the depth. dᵣ is the (average) distance between centers (i.e. vertically extending central axes) of adjacent holes along the same row of vias (e.g. dₓ in FIG. 2A). d_{c} is the (average) distance between centers of adjacent vias along the same column of vias (e.g. d_{y} in FIG. 2A). Aᵥᵢₐ(z) is the (mean) lateral cross-sectional area of a (single) via at z. In embodiments wherein the lateral cross section of the vias is known to be circular, n_{eff}(z) depends on a single physical characteristic of the vias: the average diameter of the vias at z.

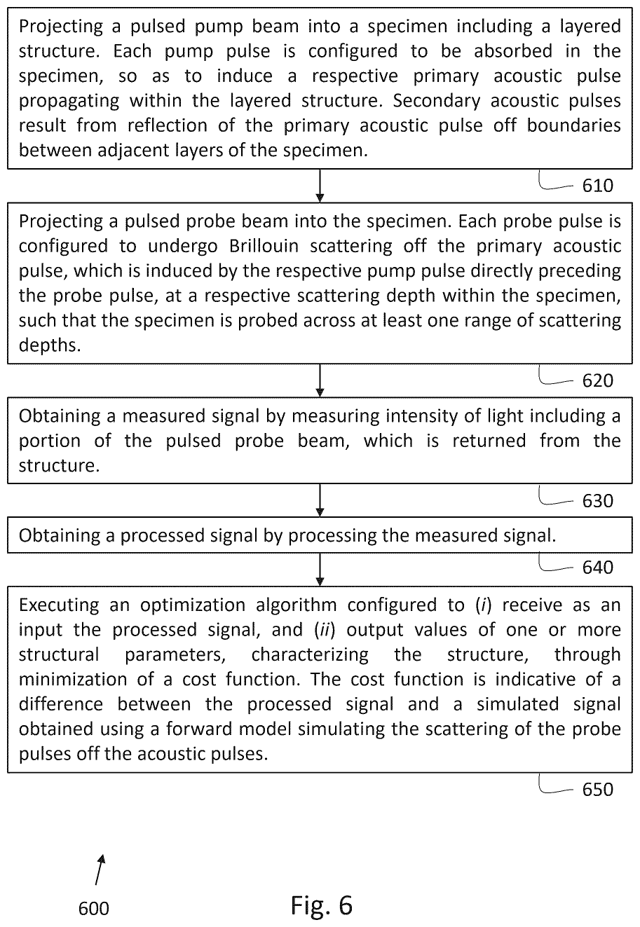

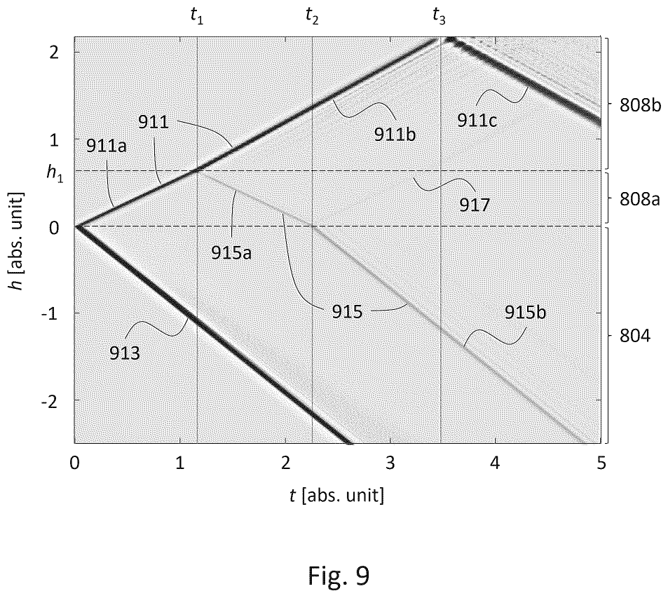

According to some embodiments, in the forward model, acoustic pulses propagating within the tested structure are modelled by mirrors. More specifically, in embodiments, wherein the tested structure is non-layered (e.g. tested structure 202, tested structure 302), the primary acoustic pulse may be modelled by a mirror moving at the local speed of sound in the propagation direction of the primary acoustic pulse. Alternatively, according to some embodiments, wherein the tested structure is layered, so that a plurality of acoustic pulses is generated within the tested structure, the acoustic pulses may be modelled by semi-transparent mirrors, as described below in the description of FIGS. 8 and 9 with respect to the method of FIG. 6.

According to some embodiments, the forward model may be trained using training data, which include GT data (i.e. of the GT specimens) and associated measurement data. The (associated) measurement data may be obtained by implementing operations 110-130 with respect to the GT specimens. More specifically, according to some embodiments, values of model parameters of the forward model may be tuned using optimization techniques (as known in the art of machine learning) based on the training data. According to some embodiments, scribe line data (defined below) may be used in training the forward model.

According to some embodiments, values of model parameters of the forward model may be tuned (e.g. prior to operation 150) based on calibration data pertaining to the profiled specimen. According to some such embodiments, and as elaborated on below, method 100 may include an initial calibration operation (which does not appear in FIG. 1), wherein the calibration data is obtained. According to some embodiments, the calibration operation may include implementing method 100 with respect to one or more scribe lines of the profiled specimen. Here, the term “scribe line” is used in an expansive manner to refer to a region of the profiled specimen, which is laterally uniform (and therefore devoid of vias) but is otherwise similar to the tested structure (in the sense of material composition and, when layered, the thicknesses of the layers and the material compositions thereof). For example, according to some embodiments, wherein the profiled specimen is a patterned wafer including via-including regions, which are to be profiled using method 100, the scribe lines may be constituted by via-free regions between the via-including regions. The via-free regions correspond to regions which are not bored during the fabrication of the patterned wafer. According to some embodiments, in order to minimize the effect of process variation on the calibration operation, a scribe line(s), which is closest (e.g. adjacent) to the tested structure, may be selected.

In a uniform medium the Brillouin frequency f_{B} is given by f_{B}=2vₛ·nₘ/λ_{prob}. nₘ is the refractive index of the medium. vₛ is the speed of sound within the medium. λ_{prob} is the wavelength of the probe pulse. Using Eq. (1), it follows that in a via-including region f_{B}(z) may be approximated to have the form f_{B}⁽⁰⁾(z)−c(z)·Aᵥᵢₐ(z). f_{B}⁽⁰⁾(z) corresponds to the Brillouin frequency profile (i.e. the dependence of the Brillouin frequency on the depth) that would be obtained were the region free of vias. c(z) depends on n₀, n₁(z), dᵣ, and d_{c}. f_{B}⁽⁰⁾(z) may be determined by implementing method 100 with respect to one or more scribe lines near the tested structure. Once determined, f_{B}⁽⁰⁾(z) may be employed to calibrate the forward model.

It is noted that in embodiments wherein the tested structure is composed of layers, f_{B}⁽⁰⁾(z) will generally be a piecewise function. When, in addition, up the inclusion of vias, the layers are uniform, on each “piece” f_{B}⁽⁰⁾(z) will be constant (i.e. f_{B}⁽⁰⁾(z) is constant within a layer). For example, in embodiments wherein the tested structure includes N layers, which—apart from including vias—are uniform, f_{B}⁽⁰⁾(z) will be defined by a set of N Brillouin frequencies {f_{B,i}⁽⁰⁾}ᵢ₌₁^{N}. For each 1≤i≤N, f_{B,i}⁽⁰⁾, is the Brillouin frequency associated with the i-th layer, as would be obtained in the absence of vias.

Additionally, or alternatively, according to some embodiments wherein the tested structure is layered and includes vias, the calibration data may specify one or more of: the concentrations of materials within each layer, the refractive index of the solid portion of a layer, the speed of sound within the solid portion, the refraction and transmission coefficients characterizing the boundary between adjacent layers (as determined by implementing method 100 with respect to one or more scribe lines), and the mean distance(s) between centers of adjacent vias.

According to some embodiments, the initial guesstimate in operation 150 may be selected taking into account at least reference data and/or calibration data of the profiled specimen.

According to some embodiments, the set of structural parameters includes a plurality of subsets of structural parameters. Each subset of structural parameters includes at least one (vertically localized) parameter pertaining to a respective increment from a set of non-overlapping vertical increments {Δzᵢ}ᵢ₌₁ⁱ^{ₘₐₓ} with zᵢ denoting the height of the i-th vertical increment Δzᵢ within the tested structure. One pertinent example of a vertically localized parameter is the (lateral) area of a via at a given height. According to some such embodiments, the optimization algorithm is executed with respect to each of the zᵢ, starting from z₁ and sequentially proceeding upwards within the tested structure to smaller zᵢ(i.e. z₁>z₂> . . . >zᵢ_{ₘₐₓ}). In the i-th execution, the optimization algorithm (i) receives as an input a processed signal derived from the measured signal up to time tᵢ=Σ_{j≤i}Δzⱼ/vₛ(zⱼ), and, optionally, any previously obtained values of the vertically localized parameters, and (ii) outputs values of the i-th vertically localized parameter(s). vₛ(z) denotes the local speed of sound at z.

FIG. 4 presents a flowchart of an operation 400, which corresponds to specific embodiments of operation 150. Operation 400 includes:
A suboperation 410, wherein an initial guesstimate \vec{g}=(g₁, g₂, . . . , g_{N}) of N structural parameters of the tested structure is selected.
A suboperation 420, wherein a forward model (e.g. an interpolator) is used to obtain a simulated signal s(\vec{g}; u) based on the guesstimate \vec{g}. (u denotes the depth within the tested structure.)
A suboperation 430, contingent on the simulated signal s(\vec{g}; u) not having converged to a processed signal m(u), wherein the guesstimate g is updated based on the simulated signal s(\vec{g}; u) and the processed signal m(u). The processed signal is derived (in operation 140) from the measured signal obtained in operation 130.
A suboperation 440, contingent on the simulated signal s(\vec{g}; u) having converged to the processed signal, wherein the guesstimate \vec{g} is output.

According to some embodiments, N=1 (i.e. a single structural parameter is to be estimated) in which case \vec{g} is a one-dimensional vector (i.e. a scalar).

According to some embodiments, the convergence criterion of operations 430 and 440 is given by ∥s(\vec{g}; u)−m(u)∥≤ε. That is, when ∥s(\vec{g}; u)−m(u)∥≤ε, s(\vec{g}; u) is considered to have converged to m(u), and, when ∥s(\vec{g}; u)−m(u)∥>ε, s(\vec{g}; u) is considered to have not converged to m(u). ∥s(\vec{g}; u)−m(u)∥ is the cost function which is to be minimized. The double vertical bars denote a norm (e.g. L¹ or L²). ε is positive constant whose value may be predetermined based on the required estimation accuracy of the set of structural parameters of the tested structure. More generally, according to some embodiments, the convergence criterion may be given by ∥F(s(\vec{g}; u))−F(m(u))∥≤ε′, wherein F is a function of the signal or a transform (e.g. a standard Fourier transform or a short-time Fourier transform) of the signal. Alternatively, according to some embodiments, the convergence criterion may be given by ∥Δ\vec{g}∥≤ε″. Δ\vec{g} is the difference between the last guesstimate (i.e. obtained in the latest iteration) and the immediately preceding guesstimate (i.e. obtained in the iteration immediately preceding the latest iteration). Failure to converge may indicate malfunction of the measurement setup, malfunction of the algorithm, and/or the profiled specimen being defective. Accordingly, according to some embodiments, if after a predefined number of iterations convergence is not achieved, operation 400 is aborted. Alternatively, according to some embodiments, if after a predefined number of iterations convergence is not achieved, the last guesstimate is output. According to some such embodiments, if one or more values of the structural parameters, as specified by the output guesstimate, falls outside a respective expected range of values, then operation 400 is aborted.

According to some embodiments, in operation 430 an optimization algorithm may be used to update the guesstimate \vec{g}. According to some embodiments, the optimization algorithm may be an algorithm known in the literature, such as a stochastic gradient descent algorithm. According to some embodiments, wherein the cost function is a sum of squares (or, more precisely, squared differences), the optimization algorithm may be a nonlinear least squares algorithm, such as a Levenberg-Marquardt algorithm. Other options may include, for instance, extensions of the gradient descent algorithm, such as the adaptive moment estimation algorithm (Adam) or the Nesterov-accelerated adaptive moment estimation algorithm (Nadam). These last options are also pertinent for other cost functions besides a sum of squares, such as a sum of absolute differences.

According to some embodiments, in suboperation 430, the guesstimate is updated according to \vec{g}→\vec{g}−\vec{d}(s(\vec{g}; u), m(u)), wherein \vec{d}(s(\vec{g}; u), m(u)) is a vector function of the last simulated signal s(\vec{g}; u) (i.e. wherein \vec{g} is the last updated guesstimate) and the measured signal m(u). According to some such embodiments, \vec{d}(s(\vec{g}; u), m(u))=\vec{d}(J,s(\vec{g}; u)−m(u)), wherein J is a Jacobian matrix of s(\vec{g}; u) at \vec{g} (i.e. \vec{g} is updated using gradient descent). Alternatively, according to some embodiments, a Hessian matrix may be employed instead of, or in addition to, J.

The initial guesstimate may be determined based on the design intent of the tested specimen (e.g. tested structure 202 or tested structure 302). The determination may be further informed by physical modeling and/or data acquired in past implementations of method 100 with respect to specimens of the same or similar intended design as the profiled specimen, optionally, supplemented by GT data pertaining to the tested specimen. According to some embodiments, the determination may take into account the processed signal. More specifically, and as explained in detail below, the initial guesstimate may be determined based on a preliminary analysis of the processed signal, whereby the obtained temporal dependence of the processed signal is approximately related to the depth-dependence of the mean area of the vias.

Alternatively, according to some embodiments, the initial guesstimate may be selected at random from a set of guesstimates. Each guesstimate in the set may be determined based on the design intent of the tested specimen, and, optionally, other relevant data as described in the previous paragraph. As a non-limiting example, according to some embodiments, the “guessed” values of each structural parameter (as specified by the guesstimates) are selected to fall within a preselected number of standard deviations (e.g. one sigma) from the expected mean value of the structural parameter.

According to some embodiments, values of non-fixed parameters of the forward model may be limited to within respective ranges of values by adding suitable penalty terms to the cost function. As a non-limiting example, according to some embodiments, the cost function may be modified to have the form ∥s(\vec{g}; u)−m(u)∥+P(\vec{g}). P(\vec{g})=0 when, for each 1≤i≤N, gᵢ^{min}≤gᵢ≤gᵢ^{max}, wherein gᵢ^{min} and gᵢ^{max} define the lower limit and upper limit, respectively, of the respective range of values to which gᵢ is to be restricted. Otherwise, P(\vec{g})=λ, wherein λ is a positive constant.

According to some embodiments, the forward model of operation 420 may be or incorporate a computer simulation, as described above in the description of operation 150 of method 100.

In practice, there may potentially exist an inherent gap between the simulated signal and the processed signal due to factors, which, according to some embodiments, are not accounted for by the forward model. Such factors may include uncontrollable factors, and/or may be due to measurement setup parameters, which are not accounted for (at least not to sufficient precision). Examples of uncontrollable factors include changes in temperature as well as various types of noise, whether environmental or in the measurement setup (e.g. laser noise, jittering and/or acceleration of a stage used to translate a mirror in the variable delay line). Examples of measurement setup parameters, which, according to some embodiments, are not accounted for, may include laser focus offsets. Other measurement setup parameters, such as the positions of various components of the measurement setup, according to some embodiments, may not be known to sufficient precision to not contribute to a simulative gap. A simulative gap may also arise due to taking into account only some of the secondary acoustic pulses in the forward model and/or due to other approximations, such as the modelling of acoustic pulses by moving semi-transparent mirrors. In principle, the simulative gap may be bridged utilizing a neural network (NN), which is trained based on GT data and associated measurement data. However, since GT data is usually highly limited (e.g. extracted from about ten or about twenty specimens), standard deep learning/artificial intelligence models (e.g. transformers), which typically require vast amounts of GT data, may not be applicable.

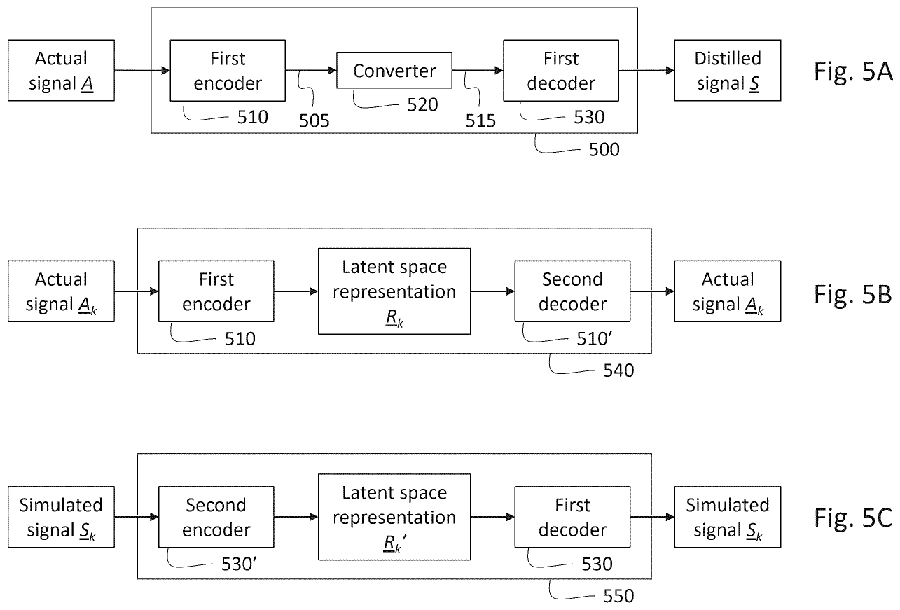

FIG. 5A depicts an encoder-decoder based computational architecture configured to bridge a simulative gap (when present) between simulated signals and actual signals, which are derived from measurement data obtained by implementing operations 110-130 of method of FIG. 1, according to some embodiments thereof. Here by “actual signal” what is meant is the measured signal following processing as described above in the description of operation 140. More specifically, FIG. 5A depicts a bridge (architecture) 500. Bridge 500 may include a (first) encoder 510, a converter 520, and a (first) decoder 530. As elaborated on below, according to some embodiments, converter 520 may be constituted by a NN or a linear regression algorithm.

In bridge 500 operation, an actual signal A is input into encoder 510 (and thereby into bridge 500). The actual signal A may be obtained by subjecting a measured signal (obtained by implementing operations 110-130 of method 100) to processing, as described above in the description of operation 140 of method 100. A first latent space representation (indicated by an arrow 505), which is output by encoder 510, is input into converter 520. Converter 520 converts the first latent space representation into a second latent space representation (indicated by an arrow 515). The second latent space representation is input into decoder 530, which, in turn, outputs a distilled signal S.

Bridge 500 is trained so as to significantly reduce (e.g. by two orders of magnitude) the dimensions of the first latent space relative to the dimensions of the space of the actual signals. The dimensions of the second latent space may be equal to, or smaller than, the dimensions of the first latent space.

According to some embodiments, bridge 500 may be incorporated into operation 140. In such embodiments, following the initial processing of the measured signal (i.e. the processing of the measured signal detailed above in the description of operation 140 prior to the description of FIGS. 5A-5C), the initially processed signal (i.e. the actual signal) is input into bridge 500. The output of bridge 500 (i.e. the distilled signal) may constitute the (final) processed signal, which is then utilized in operation 150 in the updating of the guesstimate and to establish convergence.

FIG. 5B depicts a (first) autoencoder 540 for training encoder 510, according to some embodiments. Autoencoder 540 includes encoder 510 and a second decoder 510′. Autoencoder 540 is trained under the condition that each in a set of actual signals {Aᵢ}ᵢ₌₁ⁱ^{ₘₐₓ} is taken onto itself. For example, as shown in FIG. 5B, an actual signal Aₖ (from the set), which is input into autoencoder 540, is also output thereby. More specifically, the actual signal Aₖ is encoded by encoder 510, thereby obtaining a latent space representation Rₖ of the actual signal Aₖ. The latent space representation Rₖ is input into second decoder 510′, which, in turn, outputs the original actual signal (i.e. the actual signal Aₖ). According to some embodiments, the dimensionality of the latent space may be at least one order of magnitude smaller than the dimensionality of the space of the actual signals.

FIG. 5C depicts a second autoencoder 550 for training first decoder 530, according to some embodiments. Second autoencoder 550 includes a second encoder 530′ and first decoder 530. Second autoencoder 550 is trained under the condition that each in (a set of distilled signals constituted by) a set of simulated signals {Sⱼ}ⱼ₌₁^{j}^{ₘₐₓ} is taken onto itself. For example, as shown in FIG. 5C, a simulated signal Sₖ (from the set), which is input into second autoencoder 550, is also output thereby. More specifically, the simulated signal Sₖ is encoded by second encoder 530′, thereby obtaining a latent space representation Rₖ′ of the simulated signal Sₖ. The latent space representation Rₖ′ is input into first decoder 530, which, in turn, outputs the original simulated signal (i.e. the simulated signal Sₖ). According to some embodiments, the dimensionality of the latent space may be at least one order of magnitude smaller than the dimensionality of the space of the simulated signals.

Once (first) encoder 510 and (first) decoder 530 have been trained, bridge 500 (or, more precisely, converter 520) may be trained using labelled training data. The training data may be obtained by implementing operations 110-130 with respect to each of a plurality of specimens (also referred to as “GT specimens”), thereby obtaining measured signals pertaining to each of the GT specimens, respectively. Each of the measured signals is then processed, as described above in the description of operation 140. Subsequently, each of the GT specimens is subjected to destructive measurements (e.g. using a TEM to profile lamellas extracted from the GT samples) to obtain GT data thereof. The GT data of each the GT specimens, optionally, following processing thereof, is input into the forward model to obtain a respective simulated signal. The training data includes labelled input signal-output signal pairs. Each input signal-output signal pair includes a processed signal pertaining to a respective one of the GT specimens and a simulated signal obtained based on the GT data of the (same) GT specimen. A (first) test subset of the training data may be used to evaluate the performance of bridge 500 following the training of bridge 500. The evaluation may be performed by (i) applying bridge 500 with respect to each of the input signals, and (ii) computing the distance between a distilled signal, output by bridge 500 and a respective simulated signal (i.e. obtained using the forward model with the GT data as input).

According to some embodiments, wherein operation 140 incorporates bridge 500, the training data may further include a second test subset including (additional) labelled pairs. Each of the additional labelled pairs may include one of the input signals of the first test subset and respective GT data. Following the training of bridge 500, the additional labelled pairs may be used to evaluate the performance of the optimization algorithm of operation 150. The evaluation may be performed by (i) implementing the optimization algorithm with respect to each of the input signals (of the additional labelled pairs), and (ii) computing the distance between the (final) guesstimate output by the optimization algorithm and the respective GT data.

According to some embodiments, scribe line data may be used as part of the training and/or testing of bridge 500.

According to some embodiments, the optimization algorithm may be configured to receive as an input a first difference signal given by, or indicative of, the difference between a first reference signal and the processed signal (obtained in operation 140). The first reference signal corresponds to a processed signal obtained by implementing operation 140 with respect to a measured signal, which, in turn, was obtained by implementing operations 110-130 with respect to a reference specimen, or a reference structure in the profiled specimen, whose structural parameters are known to sufficient precision. In such embodiments, the simulated signal, which is output by the forward model, may be subtracted from a second reference signal (e.g. a second simulated signal or a distilled signal obtained from the first reference signal) pertaining to the reference specimen/structure, thereby obtaining a second difference signal. The optimization algorithm may be configured to minimize the distance between the first difference signal and the second difference signal. As a non-limiting example, the reference structure may be constituted by a scribe line of the profiled specimen.

FIG. 6 presents a flowchart of a method 600 for non-destructive acousto-optic depth-metrology of layered specimens, according to some embodiments. Method 600 corresponds to specific embodiments of method 100. Method 600 includes:
An operation 610, wherein a pulsed pump beam is projected into a profiled specimen including a layered structure (i.e. a structure including a plurality of layers), which is to be tested. (The layered structure is also referred to as “the tested structure”.) Each of the pump pulses in the pump beam is configured to be absorbed in a slice (also referred to as “absorbing slice”) of the profiled specimen, so as to induce a respective primary acoustic pulse propagating within the layered structure across layers thereof. Secondary acoustic pulses result from partial reflection of the primary acoustic pulse off boundaries between adjacent layers of the layered structure.
An operation 620, wherein a pulsed probe beam is projected into the specimen. Each probe pulse in the pulsed probe beam is configured to undergo Brillouin scattering off the primary acoustic pulse, which is induced by the respective pump pulse directly preceding the probe pulse, at a respective depth within the layered structure, such that the layered structure is probed across at least one range of depths.
An operation 630, wherein a measured signal is obtained by measuring an intensity of light, which includes a portion of the pulsed probe beam returned from the profiled specimen.
An operation 640, wherein the measured signal is subject to processing to obtain a processed signal.
An operation 650, wherein an optimization algorithm is executed. The optimization algorithm is configured to (i) receive as an input at least the processed signal, and (ii) output a set of structural parameters characterizing the layered structure through minimization of a cost function. The cost function is indicative of a difference between the processed signal and a simulated signal. The simulated signal is obtained using a forward model, which simulates the scattering of the probe pulses off the primary acoustic pulses, and at least some of the secondary acoustic pulses, within the layered structure.

In each iteration thereof the optimization algorithm updates a guesstimate of the set of structural parameters, and based thereon, the simulated signal.

Method 600 may be implemented using any one of the systems described below in the description of FIGS. 12 and 13 or systems similar thereto.

According to some embodiments, the layered structure may include vias extending into the layered structure, nominally perpendicularly to the layers, from a top surface of the layered structure and onto the bulk. According to some such embodiments, the depth of the vias may be at least about 1 μm.

According to some embodiments, the bulk may be made of or include silicon. According to some embodiments, at least some of the rest of the layers (i.e. besides the bulk) may be constituted by, made of, and/or include silicon oxide (SiO₂), silicon germanium (SiGe), silicon nitride (e.g. Si₃N₄), an oxide-nitride-oxide (ONO) mixture stack, and/or a combination and/or a mixture thereof.

According to some non-limiting examples, the layered structure may be or include a V-NAND (vertical NAND; also referred to as “3D NAND”), a DRAM (dynamic random-access memory), or a 3D DRAM. According to some embodiments, the layered structure may be a preliminary structure in one of the fabrication stages of a V-NAND, a DRAM, or a 3D DRAM.

Operations 610-630 may be implemented as specified in the description of operations 110-130 of method 100, according to some embodiments. In particular, the pulsed pump beam and the pulsed probe beam may be prepared as specified in the description of operations 110 and 120, respectively, of method 100, according to some embodiments thereof, and in the description of FIGS. 2A-2D.

To facilitate the description by way of a non-limiting example, reference is additionally made to FIGS. 7A-7G. FIGS. 7A-7G depict different stages in an implementation of method 600, according to some specific embodiments thereof. FIG. 7A provides a cross-sectional view of a (profiled) specimen 700, according to some embodiments. Specimen 700 includes a layered structure 702 (e.g. a semiconductor structure including a plurality of layers; also referred to as “the tested structure”), which is to be tested, and a bulk 704 (e.g. a silicon substrate). Layered structure 702 is positioned on top of bulk 704. As a non-limiting example, layered structure 702 includes layers 708 of two types: first layers 708a and second layers 708b. First layers 708a and second layers 708b are alternately disposed one on top of the other. Second layers 708b may differ from first layers 708a in material composition (i.e. constituents and respective concentrations or relative concentrations) and/or overall concentration (i.e. mass density). According to some embodiments, first layers 708a may be characterized by a first refractive index n_{A}, and second layers 708b may be characterized by a second refractive index n_{B}≠n_{A}. Additionally, or alternatively, according to some embodiments, the speed of sound in second layers 708b may differ from the speed of sound in first layers 708a.

According to some embodiments, and as depicted in FIGS. 7A-7G, layered structure 702 is shown as including vias (e.g. empty holes) 712 projecting into layered structure 702 from a top surface 714 of layered structure 702. As a non-limiting example, each of vias 712 is assumed to project longitudinally (and vertically) into layered structure 702 and to have a circular lateral cross-section whose area decreases with the depth. According to some embodiments, vias 712 may be arranged in a periodic two-dimensional array. According to some such embodiments, the two-dimensional array is rectangular with vias 712 being arranged in rows and columns parallel to two orthogonal axes, respectively, e.g. the x-axis and y-axis, respectively, per the coordinate system depicted in FIG. 7A.

Also indicated in FIG. 7A is a layer 708a1, a layer 708a2, and a layer 708b1. Layer 708a1 is the bottommost of first layers 708a (and the bottommost of all the layers). Layer 708a2 is the second bottommost of first layers 708a. Layer 708b1 is the bottommost of second layers 708b and is sandwiched between layer 708a1 and layer 708a2.

FIGS. 7B-7E schematically depict successive stages in the generation and propagation of acoustic pulses within layered structure 702, or, more precisely, a probed portion (not numbered) of layered structure 702, according to some embodiments. The probed portion may be shaped as a cylinder whose diameter is defined by the smaller of two beam diameters: (i) the beam diameter of a pump beam (e.g. including a pump pulse 701—shown in FIG. 7B), projected on top surface 714, and (ii) the beam diameter of a probe beam (e.g. including a probe pulse 721′-shown in FIGS. 7F and 7G), projected on top surface 714.

Referring to FIG. 7B, pump pulse 701 is shown projected on top surface 714, according to some embodiments. Also indicated by a double headed arrow Dₚ is the beam diameter of pump pulse 701. Pump pulse 701 forms part of a pulsed pump beam, which is projected on layered structure 702 in accordance with operation 610. Pump pulse 701 is configured to penetrate into layered structure 702 and propagate therein onto bulk 704. Pump pulse 701 is further configured to be absorbed by bulk 704. A slice 724 (also referred to as “absorbing slice”) indicates the segment within bulk 704 in which substantially all of pump pulse 701—or substantially all of the transmitted portion of pump pulse 701 in embodiments wherein a non-negligible portion of pump pulse 701 is reflected off bulk 704—has been absorbed. Absorbing slice 724 is adjacent to layered structure 702. A thickness of absorbing slice 724 depends on the absorption length of pump pulse 701 in bulk 704.

The absorption of pump pulse 701 by absorbing slice 724 leads to heating and expansion thereof, and, consequently, the formation of a primary acoustic pulse 711, and an additional acoustic pulse 713, essentially as described above in the description of FIG. 2B. Each of primary acoustic pulse 711 and additional acoustic pulse 713 propagates away from absorbing slice 724. Primary acoustic pulse 711 travels within layered structure 702 in the direction of the negative z-axis (i.e. towards top surface 714). Additional acoustic pulse 713 may travel within bulk 704 in the direction of the positive z-axis.

FIG. 7C depicts layered structure 702 at a later time as compared to FIG. 7B. Absorbing slice 724 has cooled down and accordingly is no longer colored in black. Each of primary acoustic pulse 711 and additional acoustic pulse 713 has propagated away from absorbing slice 724. Primary acoustic pulse 711 is shown localized in a bottommost of layers 708 (i.e. layer 708a1).

FIG. 7D depicts layered structure 702 at a later time as compared to FIG. 7C. Each of primary acoustic pulse 711 and additional acoustic pulse 713 has propagated further away (as compared to FIG. 7C) from absorbing slice 724. Primary acoustic pulse 711 (or, more precisely, the portion of primary acoustic pulse 711 that is not reflected off the boundary between layer 708a1 and layer 708b1) is shown localized in layer 708b1. Also shown is a (first) secondary acoustic pulse 715. Secondary acoustic pulse 715 is momentarily localized in layer 708a1 and is seen propagating towards bulk 704. Secondary acoustic pulse 715 corresponds to a reflected portion of primary acoustic pulse 711 resulting from the crossing of primary acoustic pulse 711 from layer 708a1 into layer 708b1.

FIG. 7E depicts layered structure 702 at a later time as compared to FIG. 7D. Primary acoustic pulse 711 (or, more precisely, the portion of primary acoustic pulse 711 that is not reflected off the boundary between layer 708b1 and layer 708a2) is shown localized in layer 708a2. (Additional acoustic pulse 713 is not visible in FIG. 7E.) Secondary acoustic pulse 715 (or, more precisely, the portion of secondary acoustic pulse 715 that is not reflected off the boundary between layer 708a1 and bulk 704) has crossed into bulk 704. Also shown is a (second) secondary acoustic pulse 717. Secondary acoustic pulse 717 is shown momentarily localized in layer 708b1 and is propagating towards bulk 704. Secondary acoustic pulse 717 corresponds to a reflected portion of primary acoustic pulse 711 resulting from the crossing of primary acoustic pulse 711 from layer 708b1 into layer 708a2. Lastly, shown is a (third) secondary acoustic pulse 719. Secondary acoustic pulse 719 is momentarily localized in layer 708a1 and is seen propagating away from bulk 704. Secondary acoustic pulse 719 corresponds to a reflected portion of secondary acoustic pulse 715 resulting from the crossing of secondary acoustic pulse 715 into bulk 704.

FIGS. 7F and 7G schematically depict scattering of probe pulses off acoustic pulses within layered structure 702. Referring to FIG. 7F, a probe pulse 721′ is shown projected on top surface 714, according to some embodiments. Probe pulse 721′ forms part of a pulsed probe beam, which is projected on layered structure 702 in accordance with operation 620 following the formation of a primary acoustic pulse 711′ propagating within layered structure 702 in the direction of the negative z-axis towards top surface 714. Primary acoustic pulse 711′ was induced by a pump pulse (not shown), directly preceding probe pulse 721′, in accordance with operation 610, as described above. In particular, the pulsed probe beam and the pulsed pump beam (in which the pump pulse, which induced primary acoustic pulse 711′, is included) may be prepared using the same laser source, as has been described above. A transmitted portion 723′ of probe pulse 721′ penetrates layered structure 702. A reflected portion 725′ of probe pulse 721′ is reflected off top surface 714. Transmitted portion 723′ travels in the direction of bulk 704 and is Brillouin scattered off primary acoustic pulse 711′, as indicated in FIG. 7F by a scattered portion 727′. A transmitted portion 729′ corresponds to the part of scattered portion 727′ transmitted out of layered structure 702 through top surface 714. The depth within layered structure 702, at which transmitted portion 723′ is (Brillouin) scattered off primary acoustic pulse 711′, depends on the time interval Δt₁ by which probe pulse 721′ is delayed relative to the directly preceding pump pulse.

Also indicated in FIG. 7F is an additional acoustic pulse 713′ induced by the same pump pulse as primary acoustic pulse 711′. Additional acoustic pulse 713′ travels within bulk 704 in the direction of the positive z-axis.

Referring to FIG. 7G, a probe pulse 721″ is shown projected on top surface 714, according to some embodiments. Probe pulse 721″ is delayed by a time interval Δt₂≥Δt₁ relative to the directly preceding pump pulse (not shown). Accordingly, as compared to transmitted portion 723′, a transmitted portion 723″ (i.e. the portion of probe pulse 721″ transmitted into layered structure 702) is Brillouin-scattered at a smaller depth within layered structure 702. More specifically, transmitted portion 723″ is Brillouin-scattered off a primary acoustic pulse 711″ induced by the pump pulse directly preceding probe pulse 721″. Primary acoustic pulse 711″ propagates in the direction of the negative z-axis towards top surface 714 and is shown momentarily localized in layer 708b1. A secondary acoustic pulse 715″ propagates in the direction positive z-axis towards bulk 704 and is shown momentarily localized in layer 708a1. Secondary acoustic pulse 715″ corresponds to a reflected portion of primary acoustic pulse 711″ produced in the crossing of primary acoustic pulse 711″ from layer 708a1 into layer 708b1.

Also indicated in FIG. 7G is an additional acoustic pulse 713″ (partially shown), and a reflected portion 725″ of probe pulse 721″ reflected off top surface 714. Additional acoustic pulse 713″ was induced by the same pump pulse as primary acoustic pulse 711″ and is shown travelling within bulk 704 in the direction of the positive z-axis. A scattered portion 727″ corresponds to the part of transmitted portion 723″ Brillouin scattered off primary acoustic pulse 711″. A transmitted portion 729″ corresponds to the part of scattered portion 727″ transmitted out of specimen 700 through top surface 714. A transmitted portion 731″ corresponds to the part of transmitted portion 723″, which is not scattered off primary acoustic pulse 711″. Transmitted portion 731″ is (Brillouin) scattered off secondary acoustic pulse 715″, as indicated in FIG. 7G by a scattered portion 733″. Scattered portion 733″ travels in the direction of the negative z-axis towards top surface 714 and is (Brillouin) scattered off primary acoustic pulse 711″. A transmitted portion 735″ corresponds to the part of scattered portion 733″, which is not scattered off primary acoustic pulse 711″. Transmitted portion 735″ travels in the direction of the negative z-axis towards top surface 714. A transmitted portion 737″ corresponds to the part of transmitted portion 735″ transmitted out of layered structure 702 through top surface 714.

Portions of the transmitted portions and the scattered portions reflected off the boundaries between first layers 708a and second layers 708b are not indicated in FIGS. 7F and 7G.

Referring again to FIG. 7F, a depth u₁ at which probe pulse 721′ (or, more precisely, transmitted portion 723′) is Brillouin scattered off primary acoustic pulse 711′ is related to the time delay via Δt₁≈T_{F}+(uₘₐₓ−u₁)/vₐ. T_{F} is the formation time of the primary acoustic pulses. uₘₐₓ is the distance from top surface 714 to bulk 704. vₐ is the speed of sound within first layers 708a. Referring again to FIG. 7G, a depth u₂ at which probe pulse 721″ (or, more precisely, transmitted portion 723″) is Brillouin scattered off primary acoustic pulse 711″ is related to the time delay via Δt₂≈T_{F}+w₁/vₐ+(uₘₐₓ−w₁−u₂)/v_{b}. v_{b} is the speed of sound within second layers 708b. w₁ is the thickness (vertical extent) of each of first layers 708a. A depth u₃ at which transmitted portion 731″ is Brillouin scattered off secondary acoustic pulse 715″ is related to the time delay via Δt₂≈T_{F}+(u₃+2w₁−uₘₐₓ)/vₐ.

According to some embodiments, the pump pulses and the probe pulses may be alternately projected on specimen 700, essentially as described above in the description of specimen 200.

From optical diffraction limit considerations, according to some embodiments, a wavelength of probe pulses may be at least about two times greater than a distance between adjacent vias (e.g. a via 712a and a via 712b).

While in FIGS. 7A-7G the diameter of vias 712 is depicted as decreasing substantially linearly with the depth, the skilled person will readily perceive that the methods and systems of the present disclosure may be applied to profile other via geometries, such as, for example, geometries wherein the via has an elliptical cross-section, straight via geometries, or via geometries wherein the change in the via diameter is non-monotonic.

The forward model of operation 650 may be, or incorporate, a computer simulation, which simulates Brillouin scattering of probe pulses off acoustic pulses within a layered structure. The computer simulation may constitute a specific embodiment of the computer simulation, described above in the context of operation 150 of method 100 (and in the description of FIG. 4), with added qualifications that the tested structure is layered and that the simulated acoustic pulses, in addition to simulating a primary acoustic pulse (e.g. primary acoustic pulse 711), also simulate secondary acoustic pulses (e.g. secondary acoustic pulses 715, 717, and 719).

According to some embodiments, to lighten the computational load of the computer simulation, acoustic pulses having energies below a selectable threshold energy may be neglected.

In the same manner as described above with respect to operation 150 of method 100, according to some embodiments, in the computer simulation, a layered structure, which includes vertically extending vias (e.g. layered structure 702), is modelled by a laterally uniform structure. The laterally uniform structure has refractive index, which is equal to the effective refractive index of the layered structure as estimated prior to implementing method 600 (with respect to the layered structure) based on a model of the layered structure.

According to some embodiments, and as described in detail below in the description of FIGS. 8 and 9, in the computer simulation, acoustic pulses propagating within the layered structure are modelled by semi-transparent mirrors. Each of the acoustic pulses is modelled by a semi-transparent mirror moving at the local speed of sound in the propagation direction of the acoustic pulse.

Alternatively, according to some embodiments, the computer simulation applies the optical transfer matrix method to a model of the layered structure (e.g. a laterally uniform structure modelling the actual layered structure in embodiments wherein the actual layered structure includes vias).

Referring to FIG. 8, as mentioned above, according to some embodiments of method 600, in the computer simulation, the acoustic pulses are modelled by semi-transparent mirrors. Most generally, whenever a new acoustic pulse is formed, whether due to heating or reflection, a corresponding semi-transparent mirror is formed. Equivalently, when a semi-transparent mirror crosses from one medium (e.g. layer) to another medium (e.g. layer) of a different density, a new semi-transparent mirror is (additionally) formed, which travels away from the “originating” semi-transparent mirror.

FIG. 8 depicts a schematic of a (profiled) specimen 800, according to some embodiments. Specimen 800 includes a layered structure 802, which is to be tested, and a bulk 804 on which layered structure 802 is disposed. As a non-limiting example, layered structure 802 includes a first layer 808a and a second layer 808b on which first layer 808a is disposed. Second layer 808b may differ from first layer 808a in material composition and/or concentration (i.e. mass density). Also indicated is a top surface 814 of layered structure 802, an absorbing slice 824 included in bulk 804 and adjacent to layered structure 802, a first boundary 842 between bulk 804 and layered structure 802, and a second boundary 844 between first layer 808a and second layer 808b. First boundary 842 constitutes the top surface of absorbing slice 824.

Shown superimposed on the schematic of specimen 800 are a semi-transparent (first) mirror 811, a semi-transparent (second) mirror 813, and a semi-transparent (third) mirror 815. First mirror 811 is depicted “propagating” within second layer 808b in the direction of top surface 814 (i.e. in the direction of the negative z-axis). Second mirror 813 is depicted “propagating” within bulk 804 away from layered structure 802. Third mirror 815 is depicted “propagating” within first layer 808a in the direction of bulk 804. First mirror 811 and second mirror 813 correspond to a primary acoustic pulse and an additional acoustic pulse, respectively. The primary acoustic pulse and the additional acoustic pulse are induced due to vibrations of absorbing slice 824 within bulk 804 as a result of heating thereof. The heating results from the projection of a pump pulse (not shown) on top surface 814, in accordance with measurement operation 110, essentially as described above with respect to acoustic pulses 711 and 713 in the description of FIGS. 7B and 7C. Third mirror 815 corresponds to a secondary acoustic pulse constituting a reflected portion of the primary acoustic pulse resulting from the partial reflection thereof off second boundary 844, essentially as described above with respect to acoustic pulses 711 and 715 in the description of FIG. 7D.

Also shown superimposed on the schematic of specimen 800 is a (simulated) probe pulse 821, and a (simulated) transmitted portion 823 and a (simulated) reflected portion 825 of probe pulse 821. Transmitted portion 823 is partially reflected off first mirror 811, as indicated by a (simulated) scattered portion 827 and a (simulated) transmitted portion 831. Due to the Doppler effect, the frequency of scattered portion 827 is shifted. This shift in frequency is in-line with the Brillouin frequency shift, which would be obtained in an actual setting corresponding to the computer simulation. A (simulated) scattered portion 833 indicates the part of transmitted portion 831 reflected off first mirror 811.

The degree of reflectivity and transmission of each of the mirrors may be determined based on physical characteristics of specimen 800 (which are specified by the reference data), as well as pre-knowledge regarding the physics of acoustic wave propagation in such profiled specimens (e.g. the speed of sound). In this regard, it is noted that the reflectivity and transmission of a mirror may differ depending on whether the mirror is located within first layer 808a or second layer 808b reflecting the difference in physical characteristics (e.g. density) between the layers. According to some embodiments, wherein the density of a tested structure changes continuously with the depth-coordinate within a layer, the reflectivity and transmission of a mirror, while moving through the layer, may also change continuously as a function of the depth-coordinate.

Most generally, the semi-transparent mirrors may be two-sided in the sense of including two reflective (and semi-transparent) surfaces. As an example, in addition to a top surface 851a of first mirror 811 being (partially reflective), also a bottom surface 851b thereof may be taken to be (partially) reflective, so the returned portion of a projected probe pulse will include a contribution resulting from triple scattering: In addition to a first part of scattered portion 833 being transmitted through first mirror 811 (as indicated by a (simulated) transmitted portion 835), a second part of scattered portion 833 undergoes partial (second) reflection off bottom surface 851b. This doubly reflected portion (not shown) is partially reflected a third time off the top surface (not numbered) of third mirror 815. The triply reflected portion (not shown) is partially transmitted through first mirror 811 and next out of layered structure 802 through top surface 814.

Alternatively, according to some embodiments, e.g. in order to lighten the computational load of the computer simulation, at least some of the mirrors (e.g. later formed mirrors) may be taken to be one-sided in the sense of having only one reflective surface. As a non-limiting example, according to some embodiments, only the top surface (not numbered) of third mirror 815 may be reflective, while both top surface 851a and bottom surface 851b (of first mirror 811) may be reflective. According to some embodiments, and as depicted in FIG. 8, all the mirrors may be taken to be one-sided.

FIG. 9 is a time-depth diagram illustrating propagation and formation of acoustic pulses in the semi-transparent mirror model, according to some embodiments. The horizontal axis denotes the time t from the formation of first mirror 811 and second mirror 813. The vertical axis denotes the height h as measured from first boundary 842 in the direction of the negative z-axis. A (segmented) line 911 represents the trajectory of first mirror 811 within layered structure 802. A line 913 represents the trajectory of second mirror 813 within bulk 804. A (segmented) line 915 represents the trajectory of third mirror 815 within layered structure 802 and bulk 804. Line 911 includes three straight segments: a first segment 911a, a second segment 911b, and a third segment 911c. First segment 911a and second segment 911b differ in the respective slopes thereof. First segment 911a extends between points (t=0, h=0) and (t=t₁, h=h₁). Second segment 911b extends between points (t=t₁, h=h₁) and (t=t₃>t₁, h=H), wherein H is the height of layered structure 802 (i.e. the distance between bulk 804 and top surface 814). At t=t₁ first mirror 811 reaches second boundary 844. At t=t₃>t₁ first mirror 811 reaches the top boundary of layered structure 802. Third segment 911c represents the trajectory of first mirror 811 following the reflection thereof off the top boundary of layered structure 802. Second segment 911b is more sloped than first segment 911a in accordance with the speed of sound in second layer 808b being greater than in first layer 808a. At t=t₁ first mirror 811 reaches second boundary 844 resulting in the divergence of first segment 911a into second segment 911b and line 915 (or, equivalently, the formation of second mirror 815).

Similarly to line 911, line 915 also is also segmented. Line 915 includes two straight segments, which differ in the respective slopes thereof: A first segment 915a extends between points (t=t₁, h=h₁) and (t=t₂>t₁, h=0). A second segment 915b extends from point (t=t₂>t₁, h=0). At t=t₂ second mirror 815 reaches first boundary 842 resulting in the divergence of first segment 915a into second segment 915b and a line 917. Line 917 represents the trajectory of a semi-transparent (fourth) mirror (not shown in FIG. 8) within layered structure 802. The fourth mirror corresponds to a secondary acoustic pulse resulting from the reflection off second boundary 844 of the secondary acoustic pulse corresponding to third mirror 815.

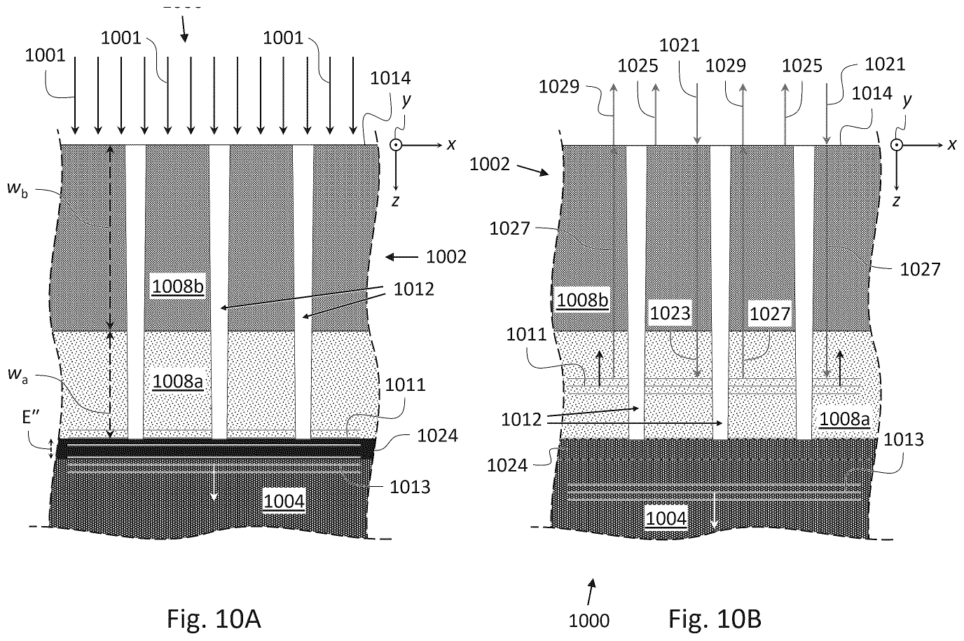

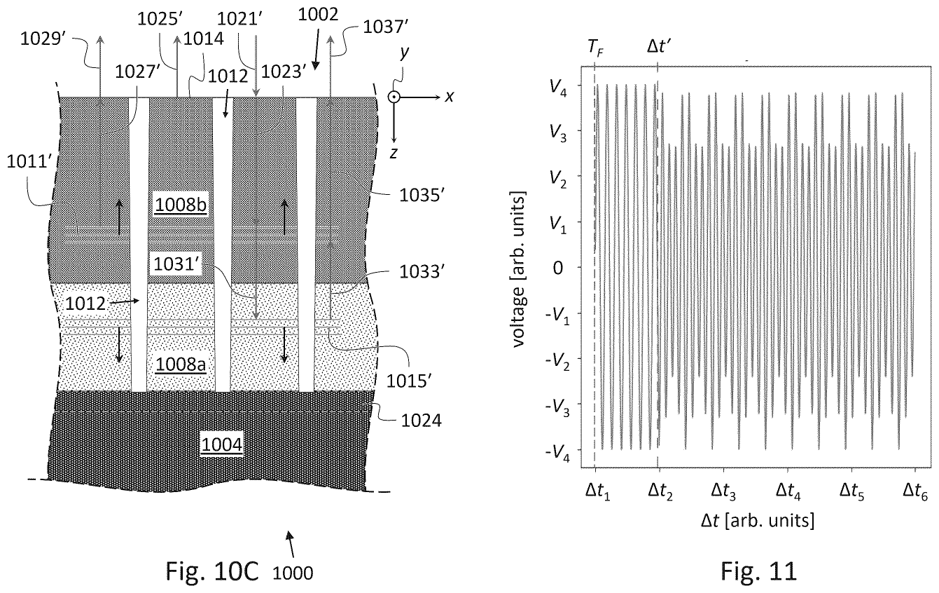

According to some embodiments, an initial guesstimate of the mean lateral cross-sectional area of the vias in a layered structure may be obtained through an iterative procedure. The iterative procedure is performed on a measured signal (e.g. obtained in operations 610-630) pertaining to the layered structure, and, more precisely, a processed signal (e.g. obtained in the operation 640) obtained from the measured signal. In the iterative procedure, an estimated Brillouin frequency profile of a first layer is used to estimate the Brillouin frequency profile of a second layer adjacent to the first layer. The estimated Brillouin frequency profiles of the first and second layers are used to estimate the Brillouin frequency profile of a third layer adjacent to the second layer, and so on. To facilitate the description, the two-layered case is first described. FIGS. 10A-10C depict a layered structure 1002, which is to be tested, according to some embodiments. More specifically, FIG. 10A presents a cross-sectional, partial view of a (profiled) specimen 1000. In addition to layered structure 1002 (also referred to as “tested structure”), specimen 1000 includes a bulk 1004 (e.g. a silicon bulk) on which layered structure 1002 is mounted. By way of a non-limiting example, layered structure 1002 is shown as including two layers: a first layer 1008a and a second layer 1008b. First layer 1008a is sandwiched between bulk 1004 and second layer 1008b. Layered structure 1002 additionally includes vias 1012 vertically extending from a top surface 1014 of layered structure 1002 to bulk 1004.

A pump pulse 1001 is shown projected on top surface 1014 (e.g. perpendicularly thereto) of layered structure 1002, in accordance with operation 610 of method 600. Pump pulse 1001 forms part of a pulsed pump beam, which is projected on layered structure 1002. Pump pulse 1001 is configured to penetrate into layered structure 1002 and propagate therein onto bulk 1004. Pump pulse 1001 is further configured to be absorbed by bulk 1004. A slice 1024 (also referred to as “absorbing slice”) indicates a segment (e.g. a thin segment) within bulk 1004 in which substantially all of pump pulse 1001—or substantially all of the transmitted portion of pump pulse 1001 in embodiments wherein a non-negligible portion of pump pulse 1001 is reflected off bulk 1004—is absorbed. Absorbing slice 1024 is adjacent to layered structure 1002. A thickness of absorbing slice 1024 depends on the absorption length of pump pulse 1001 in bulk 1004.

The absorption of pump pulse 1001 by absorbing slice 1024 leads to the heating of absorbing slice 1024. The heating of absorbing slice 1024 leads to an expansion thereof, as indicated by a double-headed arrow E″. The expansion of absorbing slice 1024 leads to the formation of a primary acoustic pulse 1011, and an additional acoustic pulse 1013, each propagating away from absorbing slice 1024. Primary acoustic pulse 1011 propagates within layered structure 1002 in the direction of the negative z-axis (i.e. towards top surface 1014). Additional acoustic pulse 1013 may propagate within bulk 1004 in the direction of the positive z-axis.

FIG. 10B presents a cross-sectional, partial view of specimen 1000 at a later time as compared to FIG. 10A: Absorbing slice 1024 has cooled down and each of primary acoustic pulse 1011 and additional acoustic pulse 1013 have propagated away from absorbing slice 1024. Primary acoustic pulse 1011 is shown propagating within first layer 1008a. As primary acoustic pulse 1011 travels through layered structure 1002, the local mass density—whereat primary acoustic pulse 1011 is momentarily localized—is temporarily modified. This temporary modification of the local mass density leads to a corresponding temporary (local) modification of the refractive index due to the elasto-optic effect.

Further depicted in FIG. 10B is a probe pulse 1021 projected on top surface 1014, according to some embodiments. Probe pulse 1021 forms part of a pulsed probe beam, which is projected on layered structure 1002 in accordance with operation 620 of method 600. The pulsed probe beam and the pulsed pump beam (in which pump pulse 1001 is included) may be prepared using the same laser source, as described above.

A transmitted portion 1023 of probe pulse 1021 penetrates layered structure 1002. A reflected portion 1025 of probe pulse 1021 is reflected off top surface 1014. Transmitted portion 1023 is Brillouin scattered-off primary acoustic pulse 1011, as indicated by a scattered portion 1027. A transmitted portion 1029 corresponds to the part of scattered portion 1027, which exits out layered structure 1002 through top surface 1014. The depth within layered structure 1002 at which transmitted portion 1023 is (Brillouin) scattered off primary acoustic pulse 1011 depends on the time delay by which probe pulse 1021 is delayed relative to the preceding pump pulse (i.e. pump pulse 1001).

Referring to FIG. 10C, a probe pulse 1021′ is shown projected on top surface 1014, according to some embodiments. Probe pulse 1021′ is delayed relative to the directly preceding pump pulse (not shown) by a time interval that is greater than the time delay of probe pulse 1021 relative to pump pulse 1001. Accordingly, as compared to transmitted portion 1023, a transmitted portion 1023′ (i.e. the portion of probe pulse 1021′ transmitted into layered structure 1002) is Brillouin-scattered at a smaller depth within layered structure 1002. More specifically, transmitted portion 1023′ is Brillouin-scattered off a primary acoustic pulse 1011′ induced by the pump pulse directly preceding probe pulse 1021′. Primary acoustic pulse 1011′ is shown propagating within second layer 1008b in the direction of the negative z-axis towards top surface 1014. A secondary acoustic pulse 1015′ is shown propagating within first layer 1008a in the direction of the positive z-axis towards bulk 1004. Secondary acoustic pulse 1015′ corresponds to a reflected portion of primary acoustic pulse 1011′ produced in the crossing of primary acoustic pulse 1011′ from first layer 1008a into second layer 1008b.

Also indicated in FIG. 10C is a reflected portion 1025′ of probe pulse 1021′ reflected off top surface 1014. A scattered portion 1027′ corresponds to the part of transmitted portion 1023′ Brillouin scattered off primary acoustic pulse 1011′. A transmitted portion 1029′ corresponds to the part of scattered portion 1027′ transmitted out of layered structure 1002 through top surface 1014. A transmitted portion 1031′ corresponds to the part of transmitted portion 1023′, which is not scattered off primary acoustic pulse 1011′. Transmitted portion 1031′ is (Brillouin) scattered off secondary acoustic pulse 1015′, as indicated in FIG. 10C by a scattered portion 1033′. Scattered portion 1033′ travels in the direction of the negative z-axis towards top surface 1014 and is (Brillouin) scattered off primary acoustic pulse 1011′. A transmitted portion 1035′ corresponds to the part of scattered portion 1033′, which is not scattered off primary acoustic pulse 1011′. Transmitted portion 1035′ travels in the direction of the negative z-axis towards top surface 1014. A transmitted portion 1037′ corresponds to the part of transmitted portion 1035′ transmitted out of layered structure 1002 through top surface 1014.

Referring also to FIG. 11, FIG. 11 is a graph depicting a voltage signal as a function of the time delay Δt between consecutively projected probe pulses and directly preceding pump pulses (e.g. probe pulse 1021 and pump pulse 1001). The voltage signal corresponds to the expected Brillouin oscillations contribution to a measured signal, which would be obtained by implementing method 600 with respect to layered structure 1002 in the absence of noise and measurement setup imperfections. Two different behaviors are visible: Until a time delay Δt=Δt′, which is indicated by the dashed vertical line, the voltage signal has a well-defined frequency. For time delays greater than Δt′, the voltage signal resembles an amplitude modulated signal (i.e. an AM signal). That is, the voltage signal can be seen to be the sum of two voltage signals, which slightly differ in frequency. Δt′=wₐ/vₐ, wherein wₐ is the thickness (vertical extent) of first layer 1008a and vₐ is the speed of sound within first layer 1008a (i.e. the propagation speed of the primary acoustic pulse within first layer 1008a). Up to the time delay Δt′ from the formation of the primary acoustic pulse, only a single acoustic pulse (i.e. the primary acoustic pulse; e.g. primary acoustic pulse 1011) propagates within layered structure 1002. Probe pulses delayed by time delays smaller than Δt′ are thus scattered only once within layered structure 1002. More specifically, up to the time delay Δt′, the voltage signal arises from scattering within (and only within) first layer 1008a, e.g. as depicted in FIG. 10B. For time delays greater than Δt′, initially, two acoustic pulses (e.g. primary acoustic pulse 1011′ and secondary acoustic pulse 1015′) propagate within layered structure 1002) and the probe pulses are scattered off each. More specifically, for time delays greater than Δt′, the voltage signal arises from scatterings within each of first layer 1008a and second layer 1008b, e.g. as depicted in FIG. 10C.

Accordingly, to obtain the initial guesstimate, a short-time Fourier transform (STFT) may be applied to the processed signal over the time interval (T_{F}, Δt′). Based on the STFT, the Brillouin frequency profile of first layer 1008a is estimated. More specifically, a function \tilde{f}_{B}^{(a)}(Δt) is first extracted. \tilde{f}_{B}^{(a)}(Δt) estimates the frequency of the Brillouin oscillations, which are induced by scattering within first layer 1008a at a time, as measured from the production of the respective primary acoustic pulse, equal to the time delay Δt. Next, using the relation n_{eff}^{(a)}(vₐ·Δt)=λ_{prb}·\tilde{f}_{B}^{(a)}(Δt)/(2vₐ) and Eq. (1), the dependence on the depth of the mean lateral cross-sectional area of the vias within first layer 1008a is estimated. Here n_{eff}^{(a)}(hₐ) denotes the effective refractive index within first layer 1008a (as estimated from the above relation). hₐ is the distance from bulk 1004.

For time delays greater than Δt′, for the purposes of obtaining the initial guesstimate, the processed signal is (preliminarily) assumed to be of the form a₁ sin(\tilde{f}_{B}^{(a)}(Δt)·Δt+φ₁)+a₂ sin(\tilde{f}_{B}^{(b)}(Δt)·Δt+φ₂). \tilde{f}_{B}^{(b)}(Δt) estimates the frequency of the Brillouin oscillations, which are induced by scattering within second layer 1008b. To obtain \tilde{f}_{B}^{(b)}(Δt), a STFT may be applied to the processed signal over a time interval (Δt′, Δt″), wherein Δt″=Δt′+min{wₐ/vₐ, w_{b}/v_{b}}. w_{b} is the thickness of second layer 1008b. v_{b} is the speed of sound within second layer 1008b. Based on the STFT and \tilde{f}_{B}^{(a)}(Δt), \tilde{f}_{B}^{(b)}(Δt) is estimated, which, in turn, is used to estimate the dependence on the depth of the mean lateral cross-sectional area of the vias within second layer 1008b in essentially the same manner as described above with respect to first layer 1008a.

According to some embodiments, the values of a₁ and a₂ may be learned in real-time using machine-learning tools based on the processed signal. According to some embodiments, the ratio a₂/a₁ may be about equal to the reflection coefficient for transition from second layer 1008b into first layer 1008a, which depends on the material compositions of layers 1008a and 1008b.

While FIGS. 10A-11 have been described in the context of the depth-profiling of a tested structure including two layers, the skilled person will readily perceive the generalization to tested structures includes N≥3 layers. For example, in the three layer case, for the purposes of obtaining the initial guesstimate, for a time delay Δt, such that the primary acoustic pulse has crossed into the third layer (i.e. the top layer), the processed signal is (preliminarily) assumed to be of the form a₁ sin(\tilde{f}_{B}^{(a)}(Δt)·Δt+φ₁)+a₂ sin(\tilde{f}_{B}^{(b)}(Δt)·Δt+φ₂)+a₃ sin(\tilde{f}_{B}^{(c)}(Δt)·Δt+φ₃). f_{B}^{(a)}(Δt) and \tilde{f}_{B}^{(b)}(Δt) may be determined as described above. \tilde{f}_{B}^{(c)}(Δt) estimates the frequency of the Brillouin oscillations, which are induced by scattering within the third layer. To obtain \tilde{f}_{B}^{(c)}(Δt), a STFT is applied to the processed signal over a time interval wherein the primary acoustic pulse is present in the third layer. Based on the STFT and \tilde{f}_{B}^{(a)}(Δt) and \tilde{f}_{B}^{(b)}(Δt), \tilde{f}_{B}^{(c)}(Δt) is estimated, which, in turn, is used to estimate the dependence on the depth of the mean lateral cross-sectional area of the vias within the third layer.

According to some embodiments, the iterative procedure may also be applied with respect to scribe line data, as part of a calibration operation, in order to determine f_{B}⁽⁰⁾(z) (i.e. the Brillouin frequency profile pertaining to the scribe line). Accordingly, in such embodiments, the determination of f_{B}⁽⁰⁾(z) amounts to the determination of a set N Brillouin frequencies {f_{B,i}⁽⁰⁾}ᵢ₌₁^{N}, wherein the index i labels the layer (and Nis the number of layers). According to some embodiments, as part of obtaining the Brillouin frequency profile, a STFT may be applied to the processed signal, as described above. Alternatively, according to some embodiments, as part of obtaining the Brillouin frequency profile a fast Fourier transform (FFT) may be applied to the processed signal.

### Systems

According to an aspect of some embodiments, there is provided a computerized system for non-destructive acousto-optic depth-metrology of layered structures. FIG. 12 presents a block diagram of such a computerized system, a computerized system 1200, according to some embodiments. System 1200 includes an acousto-optic measurement setup 1202 and a processing circuitry 1204. Measurement setup 1202 includes light generating equipment 1212 and a light sensor 1214 (or, more generally, one or more light sensors). Measurement setup 1202 may further include a controller 1218, which is functionally associated with components of measurement setup 1202 and/or communicatively associated with processing circuitry 1204.

Light generating equipment 1212 is configured to produce an (optical) pulsed pump beam, indicated by an arrow A₁, directed on a (profiled) specimen 40. Each of the pump pulses in the pulsed pump beam is configured to be absorbed by specimen 40 so as to form a respective (primary) acoustic pulse within specimen 40, as specified above in the description of operations 110 and 610 of methods 100 and 600, respectively. Light generating equipment 1212 is further configured to project on specimen 40 an (optical) pulsed probe beam, indicated by an arrow A₂, substantially simultaneously with the pulsed pump beam. Each probe pulse in the pulsed probe beam is configured penetrate into specimen 40 and to Brillouin scatter off the (up to that time) last formed (primary) acoustic pulse, as specified above in the description of operations 120 and 620 of methods 100 and 600, respectively. Each probe pulse may be delayed by a respective time interval relative to an immediately preceding pump pulse, so as to be Brillouin scattered by the last generated (primary) acoustic pulse at a respective depth within specimen 40, thereby allowing to probe specimen 40 across a range of depths and facilitating three-dimensional profiling thereof.

It is to be understood that specimen 40 does not form part of system 1200.

Light sensor 1214 is configured to obtain a measured signal by measuring the intensity of light, indicated by an arrow A₃, returned from specimen 40. The measured signal is relayed to processing circuitry 1204 from light sensor 1214, as indicated by an arrow A₄. Processing circuitry 1204 is configured to process the measured signal to obtain information indicative of a three-dimensional geometry and/or a material composition of specimen 40, as described below.

According to some embodiments, and as depicted in FIG. 12, light generating equipment 1212 may include a light source (not shown), such as a laser source, which is used in the generation of both the pulsed pump beam and the pulsed probe beam. According to some embodiments, the laser source may be a visible laser source or an infrared laser source.

According to some embodiments, light generating equipment 1212 further includes a pump modulator (not shown) and processing circuitry 1204 includes a lock-in amplifier (not shown). The pump modulator is configured to amplitude-modulate the pulsed pump beam, so as to facilitate, using the lock-in amplifier, isolating a contribution to the measured signal of a Brillouin oscillating component of a returned portion of the pulsed probe beam, as detailed above in the description of method 100 and as further specified below in the description of FIG. 13.

According to some embodiments, light generating equipment 1212 may be configured to allow controllably setting a polarization of a produced pulsed pump beam and/or a polarization of a produced pulsed probe beam. According to some such embodiments, light generating equipment 1212 may include one or more polarizers (not shown). Further, according to some embodiments, light generating equipment 1212 may be configured to allow controllably setting the intensity of the pulsed pump beam and the intensity of the pulsed probe beam and/or the beam diameters thereof.

Controller 1218 may be configured to control and synchronize operations of the various components of measurement setup 1202. In particular, controller 1218 may be configured to allow setting the values of selectable preparation parameters of the pulsed pump beam and the pulsed probe beam, as well as the striking location of the pulsed pump beam on the profiled specimen (e.g. specimen 40). Non-limiting examples of selectable preparation parameters include polarizations, intensities of each the pulsed pump beam(s) and the pulsed probe beam(s), and/or incidence angles thereof, and, according to some embodiments, a time delay between successive pump and probe pulses. Further, controller 1218 may be configured to allow setting operational parameters of light sensor 1214. For example, according to some embodiments, the bandwidth of the output signal of light sensor 1214 may be adjusted by controller 1218. According to some embodiments, wherein measurement setup 1202 includes a polarization filter (not shown) that is functionally associated with controller 1218 and configured to transmit therethrough only returned light of a certain polarization, the polarization (e.g. vertical, horizontal, right-handed circular, or left-handed circular) may be selectable by controller 1218.

Processing circuitry 1204 may include one or more processors and, optionally, volatile and/or non-volatile memory components (not shown). According to some embodiments, and as mentioned above, processing circuitry 1204 may further include a lock-in amplifier. Processing circuitry 1204 is configured to run software, stored thereon or remotely, which is configured to determine a set of structural parameters of specimen 40, based at least on the measurement data, relayed from light sensor 1214. The set of structural parameters may be indicative at least of an internal geometry and/or material composition of specimen 40. To determine the set of structural parameters of specimen 40, according to some embodiments, processing circuitry 1204 (i.e. the one or more processors therein) may be configured to execute an optimization algorithm(s), as described above in the description of operations 150 (including the specific embodiments thereof constituted by operation 400) and 650 of methods 100 and 600, respectively.

According to some embodiments, processing circuitry 1204 may further be configured to, prior to executing the algorithm(s), run software (e.g. signal processing software), stored thereon or remotely, which is configured to extract from the measured signal a processed signal indicative of a Brillouin oscillations contribution to the measured signal. According to some such embodiments, wherein measurement setup 1202 includes the pump modulator and processing circuitry 1204 includes the lock-in amplifier, the processed signal may be constituted by a demodulated signal obtained using the lock-in amplifier. According to some embodiments, the software may further be configured to extract values of key parameters from the processed signal, as described above in the description of operations 140 and 640 of methods 100 and 600, respectively. In this regard, it is noted that the extraction of the key parameters may involve use of algorithms configured to enhance the processed signal and/or the measured signal. According to some embodiments, processing circuitry 1204 may be configured to extract the STFT of the processed signal.

According to some embodiments, processing circuitry 1204 may be configured to, based on noise correlations between the pump beam and probe beam, suppress laser noise in the measured signal. According to some embodiments, processing circuitry 1204 may be configured to apply a low pass filter and/or a high pass filter to selectively remove undesired frequency ranges in the Fourier transform of the measured signal or the demodulated signal. For example, as described above in the description of method 100, in embodiments wherein the profiled specimen includes a silicon bulk on which the tested structure is mounted, a low-pass filter may be employed to remove the contribution to the measured signal due to scattering of the probe beam off an acoustic pulse propagating within the bulk. Further, according to some embodiments processing circuitry 1204 may be configured to apply: (i) a fitting algorithm in order to remove, or at least attenuate, a thermo-optic contribution to the measured signal, and/or (ii) a low-pass filter in order to average out the thermo-optic contribution.

According to some embodiments, processing circuitry 1204 may be configured to execute bridge 500.

The memory components may have stored therein information specifying expected ranges of values of various physical parameters. The physical parameters may include the structural parameters, which are to be determined, as well as other physical parameters whose values may be inferred from the measurement data. As an example, the memory components may have stored therein the frequency range in which the extracted Brillouin frequencies are expected to fall. According to some embodiments, failure of a measured value to fall within a respective expected range of values may indicate malfunction of the measurement setup and/or that the profiled specimen is defective. Similarly, according to some embodiments, failure of a determined value of a structural parameter to fall within a respective expected range of values may indicate malfunction of the software and/or that the profiled specimen is defective.

According to some embodiments, processing circuitry 1204 and controller 1218 may be housed in a common housing, for example, when implemented by a single computer.

According to some embodiments, system 1200 may further include an analog-to-digital converter (ADC; not shown) configured to convert into digital signals analog signals obtained by light sensor 1214. According to some such embodiments, light sensor 1214 may be equipped with an ADC. Additionally, or alternatively, according to some embodiments, controller 1218 and/or processing circuitry 1204 may include one or more ADCs.

FIG. 13 schematically depicts a computerized system 1300, which corresponds to specific embodiments of system 1200. System 1300 includes an acousto-optic measurement setup 1302 and a processing circuitry 1304, which correspond to specific embodiments of acousto-optic measurement setup 1202 and processing circuitry 1204, respectively. Also depicted is a (profiled) specimen 80 including a (tested) structure 82, which is being profiled by system 1300. Specimen 80 corresponds to specific embodiments of specimen 40. It is to be understood that specimen 80 and structure 82 are not included in system 1300. Measurement setup 1302 includes light generating equipment 1312, a light sensor 1314, and optionally a controller 1318, which correspond to specific embodiments of light generating equipment 1212, light sensor 1214, and controller 1218, respectively. Also indicated is a stage 1320 (e.g. a xyz stage) on which specimen 80 is placed.

Light generating equipment 1312 may include a laser source 1322 (i.e. a laser generator), a variable delay-line 1358, and a (first) beam splitter 1362. Laser source 1322 is configured to produce a pulsed laser beam including a plurality (i.e. a series) of laser pulses. According to some embodiments, laser source 1322 may be a visible laser source or an infrared laser source. Variable delay-line 1358 is configured to delay by a controllably selectable time delay (i.e. time interval) a laser pulse (and, more generally, a train of laser pulses) transmitted thereinto. According to some embodiments, and as depicted in FIG. 13, light generating equipment 1312 may further include a pump modulator 1356, and processing circuitry 1304 may include, in addition to a processor(s) 1368, a lock-in amplifier 1366. According to some embodiments, and as elaborated on below, pump modulator 1356 may be configured to amplitude-modulate a pump beam transmitted thereinto, so as to facilitate isolating a contribution to the measured signal of a Brillouin oscillating component of the returned portion of a probe beam projected on a specimen (e.g. specimen 80).

According to some embodiments, and as depicted in FIG. 13, light generating equipment 1312 may further include an objective lens 1342, a second beam splitter 1346, and a third beam splitter 1348. According to some embodiments, and as depicted in FIG. 13, measurement setup 1302 may further include an optical filter 1352.

In operation, laser source 1322 produces a laser beam including a plurality of laser pulses. To facilitate the description, the operation of measurement setup 1302 is described with respect to a single one of the laser pulses: an n-th laser pulse 1301n (in a laser beam produced by laser source 1322). Each group of M consecutively generated laser pulses may be produced within a respective timeframe of a size 1/B, wherein B is the bandwidth of light sensor 1314 (so that 1/B is the temporal resolution thereof). Accordingly, the rate of the probe pulses will be greater than the bandwidth of light sensor 1314, so that each of the intensity values, which make up the measured signal obtained by light sensor 1314, includes contributions from the returned portions of each of a plurality of probe pulses, which are consecutively projected within the timeframe 1/B.

n-th laser pulse 1301n is split by first beam splitter 1362 into two portions: a first (n-th) pulse portion 1303n1 and a second (n-th) pulse portion 1303n2. First pulse portion 1303n1 is transmitted into pump modulator 1356, and is amplitude-modulated thereby, so as to produce an n-th pump pulse 1305n. Second pulse portion 1303n2 is transmitted into variable delay-line 1358, is delayed thereby by a respective time interval Δt′, thereby producing an n-th probe pulse 1315n. A modulation frequency, employed by pump modulator 1356 to modulate the first pulse portions (as part of the modulation of the pulsed pump beam), is relayed (e.g. by controller 1318) to lock-in amplifier 1366.

Alternatively, according to some embodiments, variable delay-line 1358 may be configured to vary the path length in increments. According to some such embodiments, multiple probe pulses may be delayed at a same time delay.

According to some embodiments, and as depicted in FIG. 13, prior to impinging on structure 82, n-th pump pulse 1305n may be focused by objective lens 1342 (optionally, after passage via second beam splitter 1346). Similarly, according to some embodiments, and as depicted in FIG. 13, prior to impinging on structure 82, n-th probe pulse 1315n may be focused by objective lens 1342 (optionally, after passage via third beam splitter 1348 and reflection by second beam splitter 1346).

A first returned n-th pulse 1325n (indicated by dotted lines) corresponds to a portion of n-th probe pulse 1315n, which is reflected off structure 82. According to some embodiments, and as depicted in FIG. 13, first returned n-th pulse 1325n travels onto optical filter 1352 (optionally, after reflection by second beam splitter 1346 and passage via third beam splitter 1348). A second returned n-th pulse 1335n (indicated by dashed-double dotted lines) may correspond to a portion of n-th pump pulse 1305n, which is returned (reflected and/or scattered) from structure 82. According to some embodiments, and as depicted in FIG. 13, second returned n-th pulse 1335n travels onto optical filter 1352 (optionally, after reflection by second beam splitter 1346 and passage via third beam splitter 1348).

An n-th filtered pulse 1345n corresponds to the output of optical filter 1352. From optical filter 1352 n-th filtered pulse 1345n travels onto light sensor 1314. In embodiments wherein, as described above, M>1 laser pulses are consecutively projected within the timeframe 1/B, light sensor 1314 does not distinguish between different filtered pulses within a group of M consecutive filtered pulses, and, as such, measures the combined intensity of the M filtered pulses. Accordingly, light sensor 1314 measures n-th filtered pulse 1345n together with M−1 additional filtered pulses to obtain a single intensity value. Alternatively, according to some embodiments, wherein in each timeframe 1/B only a single laser pulse is generated, light sensor 1314 measures the intensity of n-th filtered pulse 1345n to obtain an n-th intensity value.

The measured signal (i.e. the measured intensity values, optionally, after processing) are sent to lock-in amplifier 1366. Lock-in amplifier 1366 uses the modulation signal to obtain a demodulated signal (i.e. the measured signal after processing) in which contributions due background signals and/or noise are suppressed and the Brillouin oscillations are apparent.

The demodulated signal is relayed to processor(s) 1368. Processor(s) 1368 is configured to process the demodulated signal to determine a set of structural parameters, which characterizes structure 82, as described above in the description of operations 150 and 650 of methods 100 and 600, respectively, and in the description of processing circuitry 1204 of system 1200. According to some embodiments, processor(s) 1368 may be configured to execute the optimization algorithm of FIG. 4 (i.e. operation 400) with the demodulated signal, optionally, following additional processing (e.g. as prescribed by operations 140 and 640 of methods 100 and 600, respectively), constituting the input of the optimization algorithm. According to some embodiments, the additional processing may include removal of a thermo-optic contribution to the measured signal. Additionally, or alternatively, in embodiments wherein specimen 80 includes a silicon bulk on which the tested structure is mounted, low pass filtering may be utilized to filter out a contribution to the Brillouin oscillations due to scattering off acoustic pulses within the bulk. The additional processing may also include application of a STFT to the processed signal to extract a preliminary estimate of the dependence on the time delay of the Brillouin frequency, as detailed above in the description of FIGS. 10A-11. According to some embodiments, processor(s) 1368 may be configured to execute bridge 500.

According to some embodiments, light generating equipment 1312 may further include a harmonic generation unit (not shown). The harmonic generation unit may be positioned between first beam splitter 1362 and pump modulator 1356. The inclusion of the harmonic generation unit allows changing the frequency of the pump beam relative to that of the probe beam. For example, using the harmonic generation unit, the pump beam may be prepared at the frequency e.g. of the second harmonic or the third harmonic relative to a fundamental frequency—i.e. the frequency of the laser beam generated by laser source 1322. To this end, according to some embodiments, light generating equipment 1312 may further include an optical filter (not shown) positioned between the harmonic generation unit and pump modulator 1356. The optical filter may be configured to allow selectively filtering therethrough light at one or more of the higher harmonics (i.e. of higher frequency than the first harmonic). Additionally, or alternatively, according to some embodiments, processor(s) 1368 may be configured to subject the demodulated signal to low pass filtering to filter out the contribution thereto of a reflected portion of the pump beam. Additionally, or alternatively, according to some embodiments, a harmonic generation unit may be positioned between first beam splitter 1362 and variable delay line 1358.

As used herein, according to some embodiments, the term “beam” with reference to a light beam, such as a laser beam, may refer to a continuous-wave light beam or a pulsed light beam (a train of light pulses).

In the description and claims of the application, the words “include” and “have”, and forms thereof, are not limited to members in a list with which the words may be associated.

As used herein, the term “substantially” may be used to specify that a first property, quantity, or parameter is close or equal to a second or a target property, quantity, or parameter. For example, a first object and a second object may be said to be of “substantially the same length”, when a length of the first object measures at least 80% (or some other pre-defined threshold percentage) and no more than 120% (or some other pre-defined threshold percentage) of a length of the second object. In particular, the case wherein the first object is of the same length as the second object is also encompassed by the statement that the first object and the second object are of “substantially the same length”.

According to some embodiments, the target quantity may refer to an optimal parameter, which may in principle be obtainable using mathematical optimization software. Accordingly, for example, a value assumed by a parameter may be said to be “substantially equal” to the maximum possible value assumable by the parameter, when the value of the parameter is equal to at least 80% (or some other pre-defined threshold percentage) of the maximum possible value. In particular, the case wherein the value of the parameter is equal to the maximum possible value is also encompassed by the statement that the value assumed by the parameter is “substantially equal” to the maximum possible value assumable by the parameter.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

For ease of description, in some of the figures a three-dimensional cartesian coordinate system (with orthogonal axes x, y, and z) is introduced. It is noted that the orientation of the coordinate system relative to a depicted object may vary from one figure to another. Further, the symbol ⊙ may be used to represent an axis pointing “out of the page”, while the symbol ⊗ may be used to represent an axis pointing “into the page”.

Referring to the figures, in block diagrams and flowcharts, optional elements and operations, respectively, may be delineated by a dashed line.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although operations in disclosed methods, according to some embodiments, may be described in a specific sequence, methods of the disclosure may include some or all of the described operations carried out in a different order. A method of the disclosure may include a few of the operations described or all of the operations described. No particular operation in a disclosed method is to be considered an essential operation of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purposes and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A system for non-destructive acousto-optic depth-metrology of structures, the system comprising:
a measurement setup for:
projecting on a specimen, which is to be profiled, a pulsed pump beam, such that each pump beam in the pulsed pump beam is absorbed in the profiled specimen and induces formation of at least a respective primary acoustic pulse propagating within the profiled specimen;
projecting a pulsed probe beam into the profiled specimen such that each probe pulse in the pulsed probe beam undergoes Brillouin scattering off the primary acoustic pulse, induced by the respective pump pulse directly preceding the probe pulse, at a respective depth within the profiled specimen, so as to probe the profiled specimen across at least one range of depths; and
obtaining a measured signal by sensing light comprising a portion of the pulsed probe beam returned from the profiled specimen; and
a processing circuitry for executing an optimization algorithm, which is configured to (i) receive as an input a processed signal derived from the measured signal, and (ii) output a set of structural parameters characterizing the profiled specimen through minimization of a cost function indicative of a difference between the processed signal and a simulated signal obtained using a forward model simulating the scattering of the probe pulses off at least the primary acoustic pulses.

2. The system of claim 1, wherein the optimization algorithm is configured to update, following each iteration thereof, a guesstimate of the set of structural parameters, and based thereon, the simulated signal.

3. The system of claim 1, wherein the measurement setup comprises light generating equipment and at least one light sensor;
wherein the light generating equipment is configured to generate the pulsed pump beam and the pulsed probe beam; and
wherein the at least one light sensor is configured to measure an intensity of light incident thereon, thereby obtaining the measured signal.

4. The system of claim 3, wherein the light generating equipment comprises a laser source, and wherein each of the pump beam and the probe beam originate from the laser source.

5. The system of claim 4, wherein the light generating equipment further comprises an optical modulator, which is configured to amplitude-modulate the pump beam, and wherein the processing circuitry comprises a lock-in amplifier, which is configured to use a modulation frequency of the pump beam to demodulate the measured signal in order to obtain, or as part of obtaining, the processed signal.

6. The system of claim 1, wherein the profiled specimen comprises vias, which extend into the profiled specimen from a top surface of the profiled specimen;
wherein the measurement setup is configured to project each of the pump beam and the probe beam on the top surface;
wherein the set of structural parameters quantifies at least a dependence on depth within the profiled specimen of a mean area of the vias; and
wherein a wavelength of the probe pulses is at least about two times greater than a nominal distance between adjacent vias.

7. The system of claim 1, wherein each of the pump pulses is configured to be absorbed in an absorbing slice of the profiled specimen, such that following formations thereof, each of the primary acoustic pulses propagates away from the absorbing slice.

8. The system of claim 7, wherein the profiled specimen comprises a plurality of layers comprising an absorbing layer, which comprises the absorbing slice, and at least one other layer, such that, in addition, to each primary acoustic pulse, respective secondary acoustic pulses are formed as a result of partial reflection of the primary acoustic pulse off boundaries between adjacent layers;
wherein the forward model additionally takes into account the formation of the secondary acoustic pulses by additionally simulating the scattering of the pulsed probe beam off at least some of the secondary acoustic pulses;
wherein the absorbing slice is constituted by a top sublayer of a bulk, on top of which a layered structure, comprising the rest of the layers, is disposed; and
wherein a frequency of the probe pulses is such that the layered structure is substantially transparent thereto.

9. The system of claim 1, wherein the measurement setup is configured to alternately project the pump pulses and the probe pulses; and
wherein the measurement setup is configured to delay by a controllably variable time interval each probe pulse relative to the directly preceding pump pulse, so as to facilitate probing the profiled specimen across the at least one range of depths.

10. The system of claim 6, wherein, in the forward model, the profiled specimen is simulated by a laterally uniform specimen whose refractive index n(z) equals an effective refractive index n_{eff}(z) of the profiled specimen as predetermined based on reference data pertaining to the profiled specimen; and
wherein the reference data comprise design data of the profiled specimen, and/or ground truth data of specimens of a same, or a similar, design intent as the profiled specimen.

11. The system of claim 1, wherein an initial guesstimate, which is input into the forward model in a first iteration of the optimization algorithm, is derived taking into account at least reference data of the profiled specimen and/or previously obtained calibration data pertaining to the profiled specimen; and
wherein the reference data comprise design data of the profiled specimen, and/or ground truth data of specimens of a same, or a similar, design intent as the profiled specimen.

12. The system of claim 1, wherein in the forward model each of the simulated acoustic pulses is modelled by a semi-transparent mirror travelling at a local speed of sound; or
wherein the forward model is derived using an optical transfer matrix method.

13. The system of claim 11, wherein at least some of the calibration data are obtained utilizing the system to depth-profile one or more scribe lines of the profiled specimen.

14. The system of claim 1, wherein the processed signal is indicative of a Brillouin oscillations contribution to the measured signal; and
wherein the processed signal quantifies at least a dependence of a Brillouin frequency, and/or a Brillouin amplitude of the Brillouin oscillations, on the scattering depth within the profiled specimen.

15. The system of claim 1, wherein the profiled specimen is or comprises a V-NAND, a DRAM, or a 3D DRAM or a preliminary structure in an intermediate fabrication stage of a V-NAND, a DRAM, or a 3D DRAM.

16. The system of claim 1, wherein the profiled specimen is or forms part of a patterned wafer or a preliminary structure in an intermediate fabrication stage of a patterned wafer.

17. The system of claim 6, wherein, in order to obtain an initial guesstimate of the dependence on the depth within the profiled specimen of the mean area of the vias, the processing circuitry is configured to apply a short-time Fourier transform (STFT) to the processed signal to extract a preliminary estimate of a dependence on the time delay of a Brillouin frequency.

18. The system of claim 17, wherein the profiled specimen comprises a plurality of layers, wherein, in order to obtain the initial guesstimate, the processing circuitry is configured to apply an iterative procedure, whereby the processed signal is modelled by a sine series with terms corresponding to respective contributions to the processed signal of Brillouin scatterings off the primary acoustic pulse and at least some of the secondary acoustic pulses within each of the layers.

19. The system of claim 1, wherein the set of structural parameters comprises a plurality of subsets of structural parameters, each subset of structural parameters comprising at least one vertically localized parameter pertaining to one of a set of non-overlapping vertical increments {Δzᵢ}ᵢ with zᵢ being a height of the i-th vertical increment Δzᵢ within the specimen; and
wherein the processing circuitry is configured to execute the optimization algorithm with respect to each of the zᵢ, starting from z₁ and sequentially proceeding upwards, such that in the i-th execution the optimization algorithm (i) receives as an input the processed signal up to time tᵢ=Σ_{j≤i}Δzⱼ/vₛ (zⱼ) with vₛ(zⱼ) denoting the speed of sound about zⱼ, and/or a processed signal obtained from the measured signal up to time tᵢ, and, optionally, any previously obtained values of the at least one vertically localized parameter, and (ii) outputs values of the respective at least one vertically localized parameter.

20. A method for non-destructive acousto-optic depth-metrology of specimens, the method comprising operations of:
projecting a pulsed pump beam into a specimen to be profiled: each pump pulse in the pulsed pump beam being configured to be absorbed in the profiled specimen, so as to induce formation of at least a respective primary acoustic pulse propagating within the profiled specimen;
projecting a pulsed probe beam into the profiled specimen: each probe pulse in the pulsed probe beam being configured to undergo Brillouin scattering off the primary acoustic pulse, induced by the respective pump pulse directly preceding the probe pulse, at a respective depth within the profiled specimen, so as to probe the profiled specimen across at least one range of depths;
obtaining a measured signal by sensing light comprising a portion of the pulsed probe beam returned from the profiled specimen;
subjecting the measured signal to processing to obtain a processed signal; and
executing an optimization algorithm configured to (i) receive as an input the processed signal, and (ii) output a set of structural parameters characterizing the profiled specimen through minimization of a cost function indicative of a difference between the processed signal and a simulated signal obtained using a forward model simulating the scattering of the probe pulses off at least the primary acoustic pulses.
